(19) United States
(12) Patent Application Publication
(10) Pub. No.: US 2026/0268017 A1
(43) Pub. Date: Sep. 10, 2026

(54) BEI_24HWS Terminal Sovereign Mesh Governance Engine

(71) Applicant: FURONG BEI, SAN GABRIEL, CA (US)

(72) Inventor: FURONG BEI, SAN GABRIEL, CA (US)

(21) Appl. No.: 19/178,874

(22) Filed: Apr. 15, 2025

(51) Int. Cl. G06F 21/62; H04L 9/32

(52) U.S. Cl. CPC G06F 21/6245; H04L 9/3236; H04L 9/3247; G06F 2221/2141

(57) ABSTRACT

A domain-bound Behavioral Economic Identity (BEI) terminal system is disclosed. Each BEI terminal generates a BEI-ID vector from timestamped behavioral events, terminal interactions, permission invocations, service engagements, and cross-node telemetry; records signed events in a BEI ActionLedger; binds terminal identity to a BEI domain-based terminal address through BEI DomainTalk; and enforces a BEI Permission Tree for delegation, inheritance, revocation, emergency override, and service routing. A BEI TrustNet synchronization module with an Offline Trust Vault caches signed records during disconnection and reconciles them after reconnection using timestamp, signature, quorum, CRDT, trust-weight, domain-priority, and permission-priority rules. The BEI terminal operates across personal, family, community, institutional, wallet, AI-agent, medical, financial, educational, service-provider, and domain-registry nodes as a verifiable identity, permission, dispute-evidence, recovery, privacy, and offline-resilient governance endpoint without relying on a single central authority.

### TECHNICAL FIELD

The invention relates to distributed computer systems, identity management, domain-linked service routing, behavioral event recording, permission control, trust-weighted validation, secure terminal execution, offline mesh synchronization, and machine-verifiable state reconciliation. More particularly, the invention concerns a domain-bound behavioral economic identity terminal system in which programmable sovereign terminals generate behavioral identity vectors, record signed behavioral events in an ActionLedger, bind to domain-based addresses through DomainTalk, enforce permission trees, and synchronize state through a TrustNet mesh during connected and disconnected operation.

The disclosed architecture is not merely a conventional account, website, wallet, identity credential, domain name, static database, or online-only governance service. It is an integrated terminal stack in which identity state, behavior state, domain routing state, permission state, ledger state, recovery state, privacy state, and synchronization state are maintained as coordinated machine-verifiable data objects of a terminal node.

### BACKGROUND OF THE INVENTION

### Limits of Static Identity

Conventional identity systems rely on passwords, tokens, certificates, biometrics, device credentials, wallet keys, or centrally issued account records. Such mechanisms may authenticate possession or status at a particular moment, but they do not maintain a living behavioral state that evolves with signed actions, permission invocations, service interactions, hardware-terminal interactions, network-routing interactions, recovery events, and cross-node telemetry.

### Limits of Passive Domain Names

Conventional domain names provide human-readable addressing and service location. A domain name generally does not operate as an executable behavioral identity terminal, permission tree, action ledger, offline trust vault, recovery mechanism, dispute evidence endpoint, or mesh synchronization participant. The disclosed system transforms the domain address into an executable terminal anchor.

### Limits of DAO and Wallet Systems

Conventional decentralized autonomous organizations and wallet systems often depend on token-weighted voting, static ownership, or always-online chain state. They typically do not provide terminal-level permission inheritance, behavioral trust clearance, privacy sidecar verification, domain-bound recovery, local disaster-mode operation, or deterministic reconciliation of signed offline vault records.

### Limits of Centralized IAM

Enterprise identity and access management platforms enforce roles inside institutional systems but remain server-dependent and centrally controlled. They do not give individuals, families, community nodes, institutional nodes, medical nodes, financial nodes, educational nodes, AI-agent terminals, wallet terminals, service-provider nodes, or domain registries a portable and independently operable terminal state.

### Technical Need

There is a need for a terminal architecture that combines behavioral identity generation, signed event recording, domain-terminal mapping, permission tree execution, privacy-preserving verification, emergency recovery, offline trust vaulting, and mesh synchronization into a single programmable sovereign terminal node. The terminal must continue operating during network partitions and later reconcile its state without losing audit continuity.

### SUMMARY OF THE INVENTION

In one aspect, the invention provides a domain-bound behavioral economic identity terminal system including a plurality of programmable sovereign terminals. Each terminal includes one or more processors and memory and may operate as a hardware terminal, software terminal, hosted terminal, containerized terminal, edge terminal, wallet terminal, artificial-intelligence-agent terminal, domain-registry terminal, medical node, financial node, educational node, service-provider node, community node, or hybrid terminal node.

In another aspect, the terminal includes a behavioral identity module, an ActionLedger module, a DomainTalk or domain-terminal mapping module, a permission tree module, a synchronization module, an offline trust vault, and optional secure storage, credential issuer, privacy sidecar module, dispute module, emergency module, participation value module, smart contract template executor, key rotation module, and geo-federated indexing module.

The terminal receives behavioral events, transforms those events into a behavioral economic identity vector, creates signed behavioral event records, stores the records in an ActionLedger, binds terminal identity to a domain-based terminal address, updates access rights through a permission tree, routes or denies service requests, and synchronizes or caches terminal state through TrustNet. This ordered combination produces a concrete machine-executable terminal endpoint rather than an abstract governance concept.

Specific Technical Improvements and Integration into Practical Applications

### Offline-Resilient Governance Continuity

The terminal includes an Offline Trust Vault and a deterministic reconciliation path using timestamp verification, signature verification, quorum confirmation, CRDT-based merge logic, trust-weight priority, domain-priority, and permission-priority rules. This allows local permission execution and signed action preservation during a disconnected state and a verifiable state merge after reconnection.

### Behaviorally Dynamic Trust Weighting

The BEI-ID module uses signed terminal events, permission invocations, service interactions, hardware-terminal interaction patterns, cross-node telemetry, peer receipts, and dispute outcomes to update a behavioral economic identity vector and trust weight. The system therefore avoids dependence on static credentials or token ownership alone.

### Domain-Anchored Terminal Sovereignty

The DomainTalk or domain-terminal mapping module binds terminal identity, behavioral identity state, service pointers, recovery endpoints, audit endpoints, and synchronization endpoints to a domain-based terminal address or decentralized namespace. The domain becomes an executable routing and permission anchor rather than a passive address.

### Permission Inheritance and Social-Structure Alignment

The Permission Tree module represents roles, inheritance rules, delegation rules, revocation rules, emergency overrides, recovery rules, and autonomous governance modules as machine-readable state. This allows family, institutional, community, wallet, AI-agent, medical, financial, educational, and domain-registry nodes to participate without centralized re-issuance of credentials.

### Specific Data Transformation and Terminal State Machine

The terminal receives a behavioral event, generates a BEI-ID vector update, creates a signed ActionLedger record, updates a permission tree, routes or denies a service request through a domain-based address, and synchronizes or caches the resulting state package. This is an ordered machine-executable state transformation.

### Privacy-Preserving Verification

The Privacy Sidecar and dual-mode behavioral encryption separate public verification data from private behavioral evidence. A verifier may receive a digest, proof, or trust-vector commitment while raw behavioral records remain encrypted or limited by consent and policy rules.

### Relation to BEI Ecosystem and Asset Packaging

The terminal system functions as a foundational programmable terminal layer within the BEI and 24 HWS behavioral-economic infrastructure. It can support TimeCurrency or Time of Time services, domain-anchored value exchange, behavioral banking, cross-domain governance, AI-agent permissions, wallet authorization, health access control, educational credentials, registry operations, and family or community recovery. This paragraph identifies industrial applicability and ecosystem linkage; it does not require any particular token, business model, exchange, or centralized platform to practice the invention.

### BRIEF DESCRIPTION OF THE DRAWINGS

FIG. 1 illustrates a domain-bound BEI terminal mesh architecture in which personal, family, institutional, AI-agent, wallet, service-provider, medical, financial, educational, community, and domain-registry terminals communicate through a terminal stack including BEI-ID, ActionLedger, DomainTalk, Permission Tree, TrustNet, Offline Trust Vault, privacy, recovery, participation, and geo-federated routing functions.

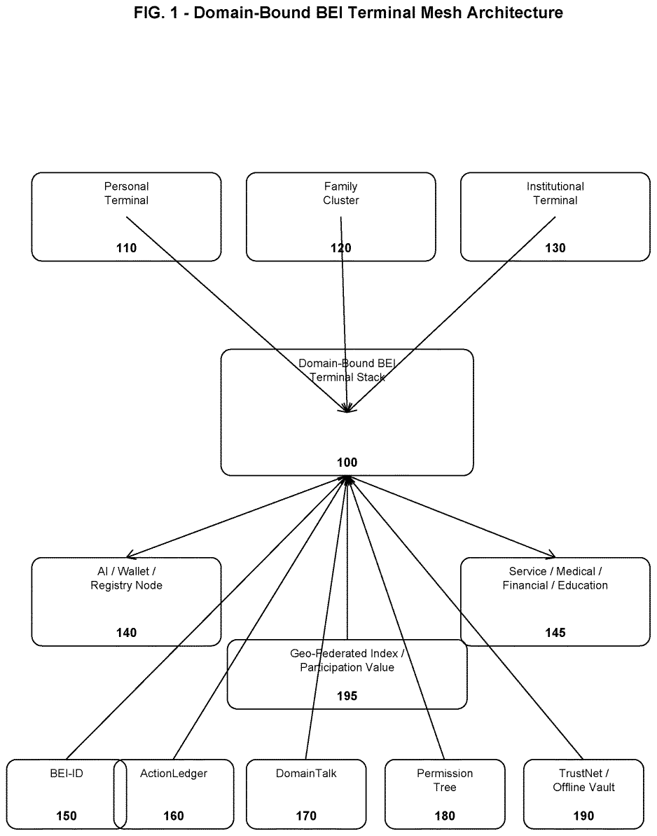

FIG. 2 illustrates an internal terminal module architecture including processor, memory, network interface, secure storage or secure enclave, behavioral identity module, ActionLedger module, domain mapping module, credential issuer, permission engine, offline trust vault, synchronization engine, privacy sidecar, recovery and key rotation, dispute and emergency, DAO template execution, and participation value modules.

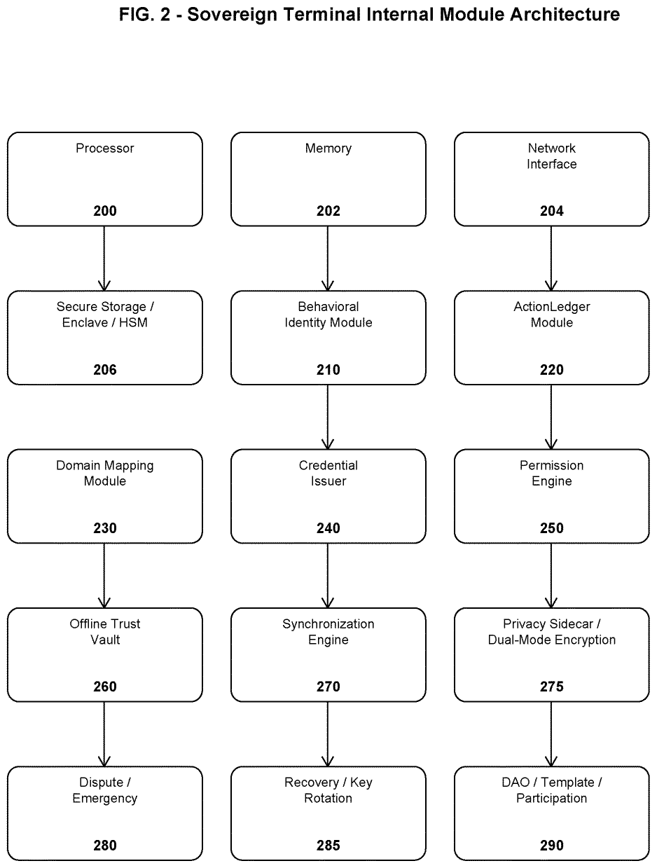

FIG. 3 illustrates a behavioral event processing and trust update flow from receiving an event through BEI-ID vector update, signed record creation, ActionLedger append, trust update, permission tree update, service routing, and mesh synchronization.

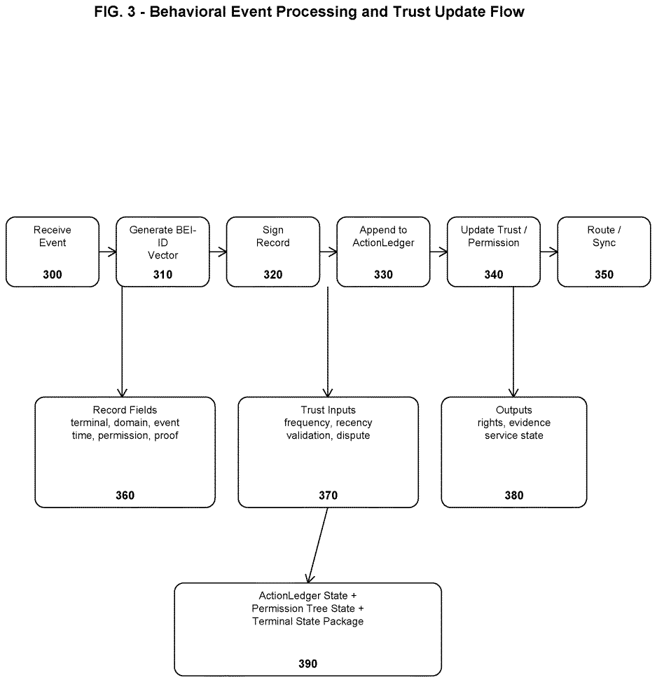

FIG. 4 illustrates offline trust vault and mesh reconciliation operation across connected, disconnected, and reconnected states including local permission execution, cache-ledger operation, peer receipts, quorum data, CRDT merge, conflict rules, and ledger merge.

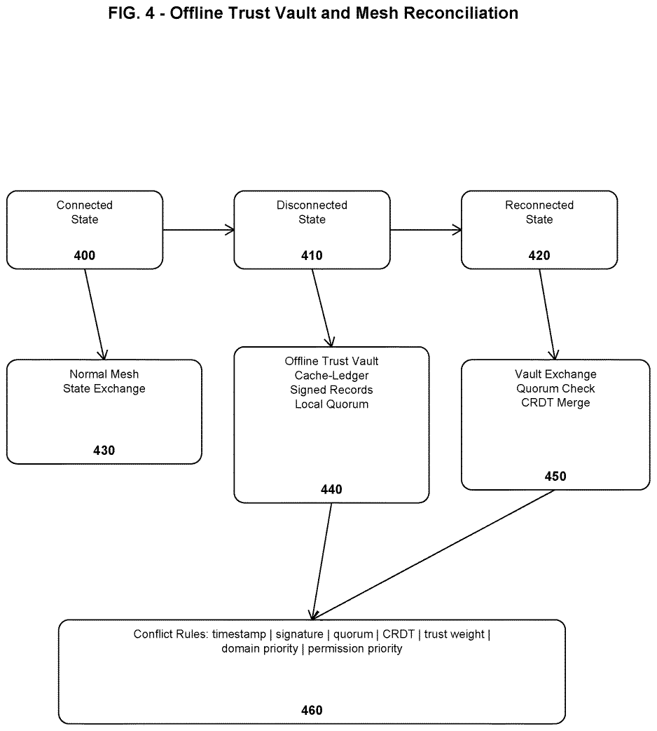

FIG. 5 illustrates permission inheritance, service routing, dispute review, emergency recovery, key rotation, participation value, credential issuance, privacy proof, and consensus node review associated with a root domain terminal and linked personal, family, institutional, wallet, AI-agent, registry, and service-provider terminals.

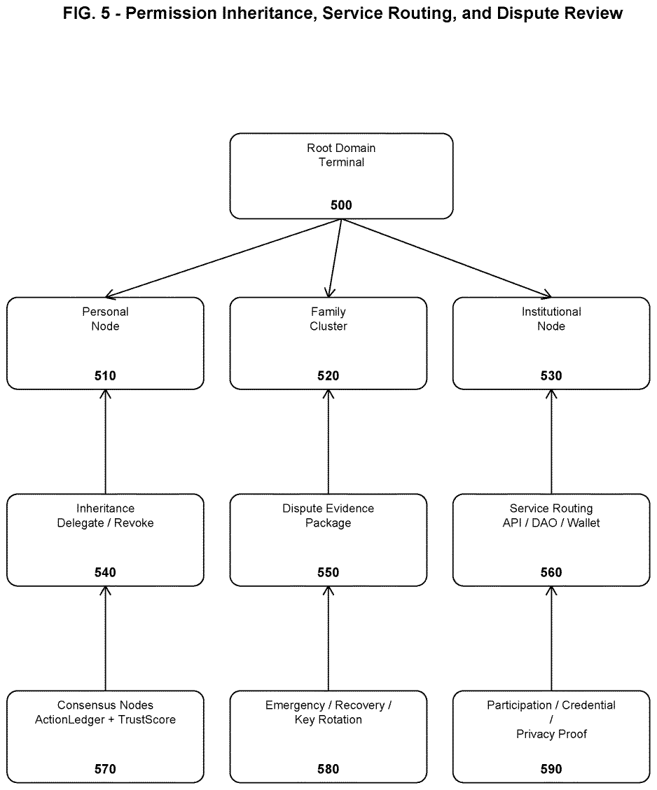

### DETAILED DESCRIPTION OF THE INVENTION

### Definitions and Non-Limiting Terminology

BEI-ID: a behavioral economic identity state, vector, credential, or protocol state generated from behavior, time-linked actions, permission invocations, terminal engagement history, trust values, domain-bound identity values, evidence of service interactions, recovery events, and synchronization events.

ActionLedger: a machine-readable ledger, log, table, chain, database, append-only event store, hash-linked state structure, or distributed ledger that records signed behavioral event records, permission changes, service interactions, dispute events, trust updates, and synchronization status.

DomainTalk: a domain-terminal mapping and service-routing mechanism that binds a terminal identifier to a human-readable domain-based terminal address and routes requests to a service, governance, credential, registry, wallet, AI-agent, audit, recovery, or synchronization endpoint.

Sovereign Terminal: a programmable terminal node controlled by or associated with an individual, family, institution, AI agent, wallet, service provider, community, medical node, financial node, educational node, or registry and configured to execute identity, permission, ledger, routing, privacy, recovery, and synchronization functions.

Permission Tree: a hierarchical, graph-based, or policy-table access-control structure defining roles, delegation, inheritance, revocation, recovery, emergency override, service authorization, smart contract template scope, and scope of action.

TrustNet: a connected or offline-first synchronization and verification mesh that exchanges terminal state packages, signed event records, trust-score deltas, vault packages, local quorum receipts, geo-federated index entries, and reconciliation decisions.

Offline Trust Vault: a local cache, storage region, ledger queue, or memory structure that stores signed records, pending actions, trust deltas, permission-state changes, service requests, peer receipts, quorum metadata, conflict flags, and synchronization metadata during network disconnection.

Privacy Sidecar: a public-private data separation structure in which a public digest, proof, or domain-bound identity value can be released while private behavioral evidence remains encrypted, withheld, or subject to consent rules.

Time-Bound Participation Value: a token, score, receipt, trust factor, service credit, governance weight, or participation unit allocated or referenced based on time-bound validated participation, service contribution, consensus participation, trust update, or governance activity recorded through the terminal stack.

The proprietary labels BEI-ID, ActionLedger, DomainTalk, TrustNet, and related terms are used for convenience and do not limit the invention to those labels. Equivalent implementations using different names remain within the disclosed technical path when they perform the claimed identity generation, signed record storage, domain-terminal mapping, permission-tree execution, offline vault caching, and mesh synchronization functions.

### Terminal System Architecture

A terminal may include a processor, memory, network interface, secure storage, local ledger storage, and executable instructions. The processor executes routines for BEI-ID generation, ledger recording, domain mapping, permission control, credential issuance, privacy sidecar handling, dispute review, emergency override, key rotation, recovery, participation value allocation, geo-federated indexing, and synchronization.

The architecture is organized so that a behavioral event is not merely stored as a passive log. The event is transformed into a signed behavioral event record, linked to a terminal identifier and domain identifier, used to update a behavioral identity vector, used to update a permission tree, and made available for domain-bound service routing, dispute evidence, recovery, participation value allocation, or TrustNet synchronization.

A terminal may be personal, family, community, institutional, AI-agent, wallet, medical, financial, educational, service-provider, or registry-oriented. The terminal type may determine default permission templates, service endpoints, recovery rules, privacy modes, participation rules, and synchronization rules, but the same core architecture remains applicable across terminal categories.

In a hosted deployment, a terminal instance may be associated with a domain address controlled by a user or organization. In a device deployment, the terminal instance may be associated with a local application or wallet. In a hybrid deployment, local signed records may be cached on a user device while service descriptors and public routing records are hosted under a domain address.

The system is not limited to hardware-only terminals or software-only terminals. A programmable sovereign terminal may be a physical device, secure mobile application, browser extension, hosted container, cloud service endpoint, edge server, wallet endpoint, registry endpoint, AI-agent endpoint, trusted execution environment, hardware security module-backed endpoint, or hybrid node, provided that it performs the described identity, ledger, mapping, permission, and synchronization functions.

### Module Descriptions

### BEI-ID Behavioral Identity Module

generates dynamic behavioral economic identity vectors from timestamped events, terminal input/output events, service interactions, permission invocation patterns, transaction-routing events, cross-node telemetry, peer receipts, role transitions, dispute outcomes, and recovery records. The module outputs vector digests and trust weight values used by the permission engine and synchronization module.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### ActionLedger Module

creates, signs, stores, verifies, and links behavioral event records, permission changes, service receipts, trust-score deltas, dispute events, recovery events, domain transfer records, and synchronization receipts. The module may use hash-linked entries, append-only databases, Merkle trees, radix trees, DAGs, local cache-ledgers, or distributed ledgers.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Domain Talk Mapping Module

validates control of a domain or namespace, creates signed binding records, publishes service pointers, maintains routing metadata, and supports adaptive name routing to current service, audit, recovery, synchronization, wallet, AI-agent, registry, or institutional endpoints.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Permission Tree Module

stores parent-child role relationships, inheritance rules, delegation rules, revocation rules, emergency overrides, recovery rules, medical condition rules, family continuity rules, smart contract template scopes, and autonomous governance module scopes.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### TrustNet Synchronization Module

exchanges terminal state packages, signed records, trust deltas, permission tree state, domain binding state, vault packages, peer receipts, quorum metadata, and reconciliation decisions with remote terminal nodes. The module can operate online or reconcile after disconnected operation.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Offline Trust Vault Module

caches signed records, pending service requests, local ledger hashes, trust-score deltas, local signatures, peer receipts, quorum metadata, and conflict flags during a disconnected state. The vault preserves evidence and continuity when a central server or global network is unavailable.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Secure Storage and Hardware Security Module

protects terminal keys, signing material, encrypted behavioral evidence, privacy sidecar data, recovery keys, and high-risk permission changes. The secure storage may be implemented as a secure enclave, trusted execution environment, HSM, hardware-backed key store, or equivalent protected storage.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Credential Issuer Module

issues machine-readable credentials to AI agents, wallets, family nodes, service providers, medical nodes, financial nodes, educational nodes, community nodes, domain registry nodes, or institutional nodes based on permission tree state.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Dispute and Emergency Module

creates dispute evidence packages, evaluates emergency override triggers, records temporary access scopes, routes evidence to consensus nodes or recovery nodes, and ensures that temporary permissions are reconciled and audited.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Privacy Mode Module

separates public verification metadata from encrypted private behavioral evidence and releases a proof, digest, privacy sidecar, or limited disclosure record according to consent, policy, service context, emergency status, or dispute status.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Recovery and Key Rotation Module

rotates keys and updates identity bindings after terminal transfer, domain transfer, compromised credentials, role transition, scheduled interval, inheritance trigger, or terminal-level intrusion event while preserving signed continuity evidence.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Geo-Federated Indexing Module

organizes terminals by domain, region, service type, jurisdiction, trust state, routing zone, or local consensus group while preserving the terminal-level identity, ledger, permission, and synchronization relationship.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Participation Value Module

allocates a time-bound participation value, governance utility value, service credit, or trust factor based on validated actions, service contribution, consensus participation, peer attestations, service quality, dispute outcomes, or time-bound contribution records.

The module may be embodied in software, firmware, a cloud-edge hybrid service, a mobile application, a wallet-like endpoint, a domain registrar service, an AI-agent endpoint, an institutional identity endpoint, or secure hardware-backed execution, provided that the module produces data that can be verified by the terminal or a remote mesh node. The module exchanges data with the BEI-ID vector, signed behavioral event records, the domain-based terminal address, the permission tree, and the synchronization engine so that terminal state can be routed, enforced, stored, audited, and reconciled.

### Representative Data Structures

### Behavioral Event Record

The Behavioral Event Record may include the following non-limiting fields: event_identifier, terminal_identifier, domain_identifier, actor_identifier, event_type, timestamp, prior_permission_state, current_permission_state, service_context, transaction_route, cryptographic_signature, verification_value, trust_delta, ledger_state_hash, synchronization_status, dispute_status. The fields may be encoded as database records, ledger entries, signed messages, JSON objects, binary records, certificates, domain registry-linked records, proof-carrying messages, or other machine-readable data objects.

By defining the Behavioral Event Record as a technical data structure and not merely as a policy statement, the terminal can compare prior and current states, verify signatures, detect conflicts, update trust values, route service requests, preserve recovery evidence, enforce privacy limits, and synchronize with other terminals.

### BEI-ID Vector

The BEI-ID Vector may include the following non-limiting fields: identity_seed, behavior_history_hash, domain_bound_identity_value, terminal_interaction_digest, service_engagement_digest, transaction_pattern_digest, role_state, trust_weight, permission_status, recovery_state, privacy_mode_flag, synchronization_epoch. The fields may be encoded as database records, ledger entries, signed messages, JSON objects, binary records, certificates, domain registry-linked records, proof-carrying messages, or other machine-readable data objects.

By defining the BEI-ID Vector as a technical data structure and not merely as a policy statement, the terminal can compare prior and current states, verify signatures, detect conflicts, update trust values, route service requests, preserve recovery evidence, enforce privacy limits, and synchronize with other terminals.

### ActionLedger Entry

The ActionLedger Entry may include the following non-limiting fields: record_number, prior_record_hash, event_payload_hash, permission_payload_hash, trust_delta, signature, peer_attestation_reference, verification_status, conflict_flag, ledger_state_hash, synchronization_window. The fields may be encoded as database records, ledger entries, signed messages, JSON objects, binary records, certificates, domain registry-linked records, proof-carrying messages, or other machine-readable data objects.

By defining the ActionLedger Entry as a technical data structure and not merely as a policy statement, the terminal can compare prior and current states, verify signatures, detect conflicts, update trust values, route service requests, preserve recovery evidence, enforce privacy limits, and synchronize with other terminals.

### Domain-Terminal Binding Record

The Domain-Terminal Binding Record may include the following non-limiting fields: domain_label, terminal_identifier, BEI_ID_reference, controller_role, routing_policy, service_pointer, audit_endpoint, recovery_endpoint, synchronization_endpoint, key_identifier, validity_metadata, transfer_status, signature. The fields may be encoded as database records, ledger entries, signed messages, JSON objects, binary records, certificates, domain registry-linked records, proof-carrying messages, or other machine-readable data objects.

By defining the Domain-Terminal Binding Record as a technical data structure and not merely as a policy statement, the terminal can compare prior and current states, verify signatures, detect conflicts, update trust values, route service requests, preserve recovery evidence, enforce privacy limits, and synchronize with other terminals.

### Permission Tree Record

The Permission Tree Record may include the following non-limiting fields: root_node, parent_node, child_node, role, access_scope, inheritance_rule, delegation_rule, revocation_rule, emergency_override_rule, recovery_rule, time_window, smart_template_reference. The fields may be encoded as database records, ledger entries, signed messages, JSON objects, binary records, certificates, domain registry-linked records, proof-carrying messages, or other machine-readable data objects.

By defining the Permission Tree Record as a technical data structure and not merely as a policy statement, the terminal can compare prior and current states, verify signatures, detect conflicts, update trust values, route service requests, preserve recovery evidence, enforce privacy limits, and synchronize with other terminals.

### Offline Trust Vault Package

The Offline Trust Vault Package may include the following non-limiting fields: vault_identifier, terminal_identifier, disconnected_start, disconnected_end, cached_records, local_ledger_hash, local_signatures, peer_receipts, quorum_metadata, conflict_flags, reconciliation_status. The fields may be encoded as database records, ledger entries, signed messages, JSON objects, binary records, certificates, domain registry-linked records, proof-carrying messages, or other machine-readable data objects.

By defining the Offline Trust Vault Package as a technical data structure and not merely as a policy statement, the terminal can compare prior and current states, verify signatures, detect conflicts, update trust values, route service requests, preserve recovery evidence, enforce privacy limits, and synchronize with other terminals.

### Terminal State Package

The Terminal State Package may include the following non-limiting fields: BEI_ID_vector_digest, permission_tree_state, ledger_state_hash, domain_binding_state, trust_score_delta, vault_reference, synchronization_status, reconciliation_metadata. The fields may be encoded as database records, ledger entries, signed messages, JSON objects, binary records, certificates, domain registry-linked records, proof-carrying messages, or other machine-readable data objects.

By defining the Terminal State Package as a technical data structure and not merely as a policy statement, the terminal can compare prior and current states, verify signatures, detect conflicts, update trust values, route service requests, preserve recovery evidence, enforce privacy limits, and synchronize with other terminals.

### Dispute Evidence Package

The Dispute Evidence Package may include the following non-limiting fields: dispute_identifier, claimant_terminal, respondent_terminal, record_reference_list, permission_state_references, role_state_references, trust_history_references, domain_mapping_reference, selected_evidence, requested_outcome, outcome_record. The fields may be encoded as database records, ledger entries, signed messages, JSON objects, binary records, certificates, domain registry-linked records, proof-carrying messages, or other machine-readable data objects.

By defining the Dispute Evidence Package as a technical data structure and not merely as a policy statement, the terminal can compare prior and current states, verify signatures, detect conflicts, update trust values, route service requests, preserve recovery evidence, enforce privacy limits, and synchronize with other terminals.

### Privacy Sidecar Record

The Privacy Sidecar Record may include the following non-limiting fields: public_digest, encrypted_private_evidence, consent_node, disclosure_level, expiry, proof_type, verification_key_reference, policy_reference. The fields may be encoded as database records, ledger entries, signed messages, JSON objects, binary records, certificates, domain registry-linked records, proof-carrying messages, or other machine-readable data objects.

By defining the Privacy Sidecar Record as a technical data structure and not merely as a policy statement, the terminal can compare prior and current states, verify signatures, detect conflicts, update trust values, route service requests, preserve recovery evidence, enforce privacy limits, and synchronize with other terminals.

### Machine-Readable Credential

The Machine-Readable Credential may include the following non-limiting fields: credential identifier, subject_terminal, issuer_terminal, role_scope, service_endpoint, validity_window, privacy_mode, revocation_condition, signature. The fields may be encoded as database records, ledger entries, signed messages, JSON objects, binary records, certificates, domain registry-linked records, proof-carrying messages, or other machine-readable data objects.

By defining the Machine-Readable Credential as a technical data structure and not merely as a policy statement, the terminal can compare prior and current states, verify signatures, detect conflicts, update trust values, route service requests, preserve recovery evidence, enforce privacy limits, and synchronize with other terminals.

### Recovery Event Record

The Recovery Event Record may include the following non-limiting fields: lost_or_transferred_terminal, recovery_actor, continuity_proof, new_key_state, verification_record, updated_domain_binding, affected_permission_node, signature. The fields may be encoded as database records, ledger entries, signed messages, JSON objects, binary records, certificates, domain registry-linked records, proof-carrying messages, or other machine-readable data objects.

By defining the Recovery Event Record as a technical data structure and not merely as a policy statement, the terminal can compare prior and current states, verify signatures, detect conflicts, update trust values, route service requests, preserve recovery evidence, enforce privacy limits, and synchronize with other terminals.

### Geo-Federated Index Record

The Geo-Federated Index Record may include the following non-limiting fields: region_identifier, domain_zone, terminal_prefix, routing_weight, jurisdiction_flag, local_consensus_zone, service_category, policy_reference, update_epoch. The fields may be encoded as database records, ledger entries, signed messages, JSON objects, binary records, certificates, domain registry-linked records, proof-carrying messages, or other machine-readable data objects.

By defining the Geo-Federated Index Record as a technical data structure and not merely as a policy statement, the terminal can compare prior and current states, verify signatures, detect conflicts, update trust values, route service requests, preserve recovery evidence, enforce privacy limits, and synchronize with other terminals.

### Smart Contract Template Record

The Smart Contract Template Record may include the following non-limiting fields: template_identifier, version, trigger_condition, permission_output, execution_limit, rollback_condition, policy_hash, signature. The fields may be encoded as database records, ledger entries, signed messages, JSON objects, binary records, certificates, domain registry-linked records, proof-carrying messages, or other machine-readable data objects.

By defining the Smart Contract Template Record as a technical data structure and not merely as a policy statement, the terminal can compare prior and current states, verify signatures, detect conflicts, update trust values, route service requests, preserve recovery evidence, enforce privacy limits, and synchronize with other terminals.

### Participation Value Record

The Participation Value Record may include the following non-limiting fields: terminal_identifier, time_window, contribution_type, consensus_participation, service_quality_value, validation_status, trust_weight_before, trust_weight_after, allocation_value, expiry_or_vesting_rule. The fields may be encoded as database records, ledger entries, signed messages, JSON objects, binary records, certificates, domain registry-linked records, proof-carrying messages, or other machine-readable data objects.

By defining the Participation Value Record as a technical data structure and not merely as a policy statement, the terminal can compare prior and current states, verify signatures, detect conflicts, update trust values, route service requests, preserve recovery evidence, enforce privacy limits, and synchronize with other terminals.

### Mathematical and Algorithmic Support

### BEI-ID Vector and Trust Weight Update

The behavioral identity update may be expressed as T_new=clamp(T_min, T_max, alpha*T_old+(1−alpha)*sum_i(w_i*F_i(x_i)*exp(−lambda*(t_now−t_i)))+beta*Q+gamma*A−delta*D). T_old is the prior trust weight; x_i are normalized behavioral features; w_i are feature weights; F_i is a feature transform; lambda is a time-decay parameter; Q is a quorum confirmation value; A is a peer attestation value; D is a dispute or invalidation value; and alpha controls persistence of prior state. This formula is exemplary and can be replaced by equivalent deterministic, probabilistic, or machine-learning scoring functions provided that the scoring function produces a verifiable trust-weight update from signed terminal events.

### Regenerative Trust Clearance

For each newly signed behavioral event, the terminal determines whether the event is verified, provisional, disputed, stale, or invalidated. Verified events increase trust according to weight, recency, and service quality. Disputed or invalidated events reduce trust or route the terminal to review. Older events decay, so the terminal can regenerate active authorization state from current behavior rather than static credentials.

### Deterministic Vault Reconciliation

The reconciliation routine may first reject records with invalid signatures, then compare terminal identifiers, timestamps, sequence counters, ledger hashes, and domain binding states. If two records conflict, the routine applies a CRDT merge where possible; otherwise it applies an ordered rule set using quorum confirmation, trust-weight priority, domain-priority, permission-priority, and emergency-scope limitations. The selected outcome is written as a reconciliation event.

### Privacy Sidecar Verification

The terminal creates a public digest of the behavioral evidence and stores raw evidence in encrypted form. A service provider or consensus node receives the digest, domain-bound identity value, permission state, and a verification key reference. The verifier confirms that the digest matches the proof while raw evidence remains undisclosed unless a consent rule, emergency rule, or dispute rule authorizes disclosure.

### Adaptive Name Routing

The domain-terminal mapping module maps a persistent domain label to current service, audit, recovery, and synchronization endpoints. A route update is accepted only when a signed binding record verifies domain control, a valid key identifier, a service pointer, and an applicable permission rule. This prevents a domain address from becoming a passive pointer detached from terminal authority.

### Family Inheritance Execution

When an inheritance trigger occurs, the terminal identifies the affected parent and child nodes, confirms the trigger through a signed event or external proof, evaluates any guardian, heir, waiting-period, or emergency rule, rotates relevant keys if necessary, records the updated permission tree, and sends state packages to family and recovery nodes. Temporary delegation and permanent inheritance are represented as different permission states.

### Local Quorum During Disaster Mode

A terminal in disaster mode discovers nearby terminals, exchanges minimal signed status messages, limits local actions to emergency scope, and requests peer receipts from trusted nodes. The peer receipts are stored in the vault package. Upon reconnection, the receipts become quorum metadata used by the reconciliation routine.

### Representative Operating Flows

### Terminal Initialization

The flow may include the following operations: create terminal identifier; establish BEI-ID seed; validate processor, memory, secure storage, and network interface; bind domain-based terminal address; create initial permission tree; initialize ActionLedger and ledger state hash; publish service, audit, recovery, and synchronization endpoints; generate initial terminal state package.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Domain Binding

The flow may include the following operations: receive domain label, namespace identifier, registry handle, or URL; validate control by DNS proof, registry proof, certificate proof, wallet signature, or institutional authorization; create signed domain-terminal binding record; publish service pointer and recovery endpoint; write binding event to ActionLedger; synchronize binding state through TrustNet.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Behavioral Event Processing

The flow may include the following operations: receive behavioral event or service interaction; normalize event fields and timestamp; compute event digest and verification value; generate BEI-ID vector update; create signed behavioral event record; append record to ActionLedger; update trust weight and permission tree; route or deny the service request; include result in terminal state package.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Permission Update

The flow may include the following operations: identify requested subject, object, action, role, and access scope; select tree rule and inheritance path; evaluate trust threshold, privacy mode, emergency rule, and service context; record prior and new permission state; apply delegation, revocation, recovery, or override; write signed permission record to ActionLedger; synchronize or cache the update.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Offline Operation

The flow may include the following operations: detect network partition or degraded network state; switch to local enforcement mode; cache signed records and local ledger hashes; collect local peer receipts when available; mark affected records as provisional; preserve conflict flags and reconciliation metadata; restrict operations according to local permission and emergency rules.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### TrustNet Reconciliation

The flow may include the following operations: exchange vault packages after reconnection; verify terminal identifiers, signatures, timestamps, and ledger hashes; request missing entries or proof objects; apply quorum and CRDT rules; apply trust-weight, domain-priority, and permission-priority ordering; write reconciliation receipt to ActionLedger; update domain routes, trust deltas, and permission state.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Dispute Review

The flow may include the following operations: generate dispute evidence package; select consensus verification node, geo-federated node subset, recovery node, institutional review node, or registry dispute node; release public proofs and selected private evidence subject to privacy mode; evaluate event records, timestamps, permission states, and trust-score deltas; record outcome and update permissions if necessary.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Key Rotation and Recovery

The flow may include the following operations: detect terminal transfer, domain transfer, compromised credential, role transition, inheritance trigger, or scheduled rotation interval; create recovery event record; rotate key or issue new key identifier; preserve behavioral continuity through signed continuity proof; update domain-terminal binding and permission tree; synchronize recovery state.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Participation Value Generation

The flow may include the following operations: identify time-bound contribution or consensus participation; validate the contribution against ActionLedger records and peer receipts; compute a trust or participation delta; apply vesting, expiry, or service credit rule; record participation value in ActionLedger; use value for routing priority, governance weight, service access, or reputation.

Each operation may create a signed record, update a permission tree, produce a credential, update a domain-terminal mapping, create a participation value, issue a privacy proof, trigger key rotation, or generate a terminal state package for synchronization. Alternative implementations may reorder, combine, or split steps while preserving the integrated relationship among BEI-ID generation, ActionLedger recording, DomainTalk mapping, permission tree execution, offline trust vault caching, and TrustNet synchronization.

### Pseudocode Examples

### BEI-ID Update Routine

1. input event E, prior vector V_old, prior trust T_old, domain binding B, permission state P
2. normalize event fields and compute digest H_E
3. verify timestamp, terminal_identifier, domain identifier, and signature candidate
4. compute feature values x_i from event type, hardware interaction, service quality, peer receipts, and dispute status
5. apply decay-weighted trust formula to produce T_new
6. generate V_new including behavior_history_hash, role_state, trust_weight, permission_status, recovery_state, and privacy_mode
7. write signed BEI-ID update record to ActionLedger and return V_new

### ActionLedger Record Routine

1. input terminal_id, domain_id, event_type, permission_state_before, permission_state_after, payload_digest
2. load prior ledger_state_hash
3. create record with timestamp, prior hash, payload hash, permission payload, trust delta, and verification value
4. sign record using terminal key or hardware-backed key
5. append record to selected verifiable data structure
6. output new ledger_state_hash and synchronization status

### Domain Talk Binding Routine

1. receive domain_label and terminal_identifier
2. validate control using DNS proof, registry proof, certificate proof, decentralized namespace proof, wallet signature, or institutional authority evidence
3. create signed domain-terminal binding record with routing policy, service pointer, key identifier, and validity metadata
4. publish service, audit, recovery, and synchronization endpoints
5. write binding event to ActionLedger and make binding state available to TrustNet

### Permission Evaluation Routine

1. receive service request at domain-based terminal address
2. locate permission tree node matching subject, object, action, and scope
3. evaluate role state, trust threshold, inheritance rule, delegation rule, emergency rule, privacy mode, and service context
4. route request when the rule is satisfied or deny the request when not satisfied
5. write signed service request record and permission decision to ActionLedger

### Offline Reconciliation Routine

1. when disconnected, cache signed records, ledger hashes, peer receipts, and conflict flags in Offline Trust Vault
2. when reconnected, exchange vault package with remote terminal nodes
3. verify signatures, timestamps, ledger hashes, domain bindings, and peer receipts
4. apply CRDT merge when records are mergeable
5. apply trust-weight, domain-priority, permission-priority, and emergency-scope rules when records conflict
6. write reconciliation receipt and update terminal state package

### DETAILED EMBODIMENTS

### Personal Sovereign Terminal

A person-controlled terminal address maintains identity, permission, service-routing, and ledger state for personal services, wallets, credentials, data consent, and local governance actions. The terminal evaluates a request against the BEI-ID vector and permission tree, records the decision in the ActionLedger, and publishes or withholds the result through the domain-based endpoint.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Family Governance and Inheritance Cluster

A family root domain or family cluster associates individual terminals with parent-child permission relationships. The cluster may support guardian roles, heir roles, recovery roles, family medical access, shared wallet authorization, inheritance trigger events, and time-bound delegated powers. Permission changes are signed, recorded, and synchronized so that a later dispute can reconstruct the prior and current family permission states.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Community and Regional Mesh

A community mesh includes school, neighborhood, municipal, or regional terminals. Local nodes may continue limited governance operations during a network outage, collect local peer receipts, and later reconcile vault packages through TrustNet. Geo-federated indexing limits reconciliation to relevant region, domain, or service groups.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Institutional Access Terminal

An institution may issue machine-readable credentials or service permissions to personal or family terminals without assuming central custody of all behavioral evidence. The institution receives proofs, digests, or selected evidence and writes a signed service receipt to the ActionLedger.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### AI-Agent Authority Terminal

An AI-agent terminal receives a role-scoped machine-readable credential tied to a domain, permission node, and revocation condition. Instructions sent by or to the AI agent are checked against the permission tree and recorded as signed behavioral events, allowing later audit, revocation, and dispute review.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Wallet Authorization Terminal

A wallet terminal stores transaction request state, spending role, recovery delegate, service provider rule, and ledger-linked authorization proof. A transaction request can be routed through a domain-based terminal address and denied when the selected permission rule or trust threshold is not satisfied.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Domain Registry or Registrar Node

A registry terminal validates domain control, creates a domain-terminal binding record, supports transfer or recovery of domain-linked terminal state, and routes registry disputes to a verification node or registry dispute node. The terminal preserves signed relationships among domain state, terminal identity, key rotation, and permission state.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Medical Consent Terminal

A patient, caregiver, clinic, or service provider terminal can issue limited clinical access credentials. Emergency override rules grant time-limited access and create signed override records that must be reconciled and audited after the emergency condition ends.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Financial Trust Terminal

A financial terminal uses behavior-bound identity, privacy sidecar proofs, trust-weight values, and signed service receipts to support onboarding, authorization thresholds, risk-tiered access, and dispute evidence without exposing unnecessary raw behavior evidence.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Education Credential Terminal

An education terminal stores learning participation records, role scopes, course credentials, instructor permissions, family access rules, and time-bound service access. The same signed record and permission-tree structure supports credential issuance and revocation.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Disaster Recovery Terminal

During a systemic network failure, a disaster terminal switches to offline mode, caches local records in an Offline Trust Vault, collects peer receipts over ad-hoc wireless or wired networks, enforces emergency rules with limited scope, and merges signed deltas when connectivity returns.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Cross-Domain Service Routing Terminal

A cross-domain bridge maps policy trees across domain zones or institutional policies while preserving the signed relationship between BEI-ID state, ActionLedger state, domain binding state, and TrustNet synchronization state.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Privacy-Preserving Verification Terminal

A privacy terminal releases a digest, proof, or encrypted sidecar while raw behavioral evidence remains protected. The recipient can verify a trust category, permission status, or domain binding status without receiving every underlying event record.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Time-Bound Participation Terminal

A participation terminal allocates a participation value, trust weight, service credit, or governance utility value based on time-bound verified events, consensus participation, service quality, peer attestations, and dispute outcomes recorded in the ActionLedger.

In this embodiment, behavior events produce BEI-ID updates, ActionLedger records events and receipts, DomainTalk or another domain-terminal mapping process maps the terminal to a domain-based address, the permission tree controls access and inheritance, the privacy sidecar controls disclosure, and TrustNet or another mesh synchronization process synchronizes state across terminal nodes. The embodiment is exemplary and does not limit the invention to a particular industry, device class, software platform, blockchain, naming system, token vocabulary, or governance terminology.

### Anti-Circumvention and Equivalent Implementations

### Renaming BEI-ID

A competing system may avoid the label BEI-ID, but if it generates a dynamic behavioral identity value from recorded terminal events and uses that value to control terminal permissions or routing, it performs the disclosed identity function.

### Replacing ActionLedger Terminology

A system may call the record store an audit log, state log, activity ledger, receipt store, or service log. If it stores signed behavioral event records used for trust, permission, dispute, or synchronization state, it remains within the disclosed technical path.

### Substituting a Namespace for a Domain

A system may use subdomains, wallet names, decentralized identifiers, URLs, registry handles, service names, or namespaces. If the name is bound to a terminal identifier and used for routing terminal permissions, it implements an equivalent domain-terminal mapping.

### Pure Blockchain DAO Substitution

A blockchain-only governance system may record votes or transactions, but without the terminal-level BEI-ID, domain-terminal mapping, permission tree, offline trust vault, and mesh synchronization path, it does not achieve the disclosed integrated terminal operation.

### Pure DID Wallet Substitution

A DID wallet may hold credentials, but without behavior-updated trust, signed event records, permission inheritance, domain-bound service routing, and vault reconciliation, it lacks the disclosed terminal governance stack.

### Central IAM Substitution

An identity and access management server may control roles centrally, but it does not provide a user-owned domain-bound terminal that continues local governance during network partition and later reconciles signed state packages.

### Offline Storage Alone

Offline storage alone caches files. The disclosed terminal caches signed governance events, permission state, ledger hashes, trust states, peer receipts, and reconciliation metadata and later reconciles them through mesh verification.

### Token-Only Incentive Substitution

A token system may reward participation, but the disclosed participation value is tied to signed behavioral records, terminal state, permission logic, and domain-linked routing state.

### Support for Claimed Subject Matter

### Claim 1

Claim 1 is supported by the processor, memory, programmable sovereign terminal, BEI-ID module, ActionLedger module, DomainTalk mapping module, Permission Tree module, and TrustNet synchronization module described throughout this specification.

### Claim 10

Claim 10 is supported by the operational flow in which a terminal receives a behavioral event, generates a BEI-ID vector, creates a signed record, stores the record, binds terminal identity to a domain address, updates permission state, routes a service request, and synchronizes state through TrustNet.

### Claim 16

Claim 16 is supported by the instructions and computer-readable medium embodiments that cause a terminal to generate identity vectors, store signed ActionLedger records, bind terminal identifiers to domain addresses, maintain permission trees, cache records offline, synchronize after reconnection, and route service requests.

### INDUSTRIAL APPLICABILITY

The invention has industrial applicability in personal identity, family and inheritance management, community governance, decentralized finance interfaces, health access and consent, education credentialing, AI-agent authorization, wallet permissions, domain registry operations, service provider integration, disaster-mode governance, cross-domain policy translation, and institutional access control. The invention provides a terminal foundation for BEI and related systems while remaining implementable through ordinary computing infrastructure, secure storage, network interfaces, databases, cryptographic libraries, domain services, and synchronization protocols.

The claims and detailed description are structured so that the broad infrastructure is protected by system, method, and computer-readable medium claims, while dependent claims and embodiments support vertical implementations in AI, wallet, medical, financial, education, family, registry, emergency, privacy, and cross-domain routing contexts. This structure supports licensing, continuation practice, and asset packaging without placing filing strategy, valuation assumptions, or internal editorial notes into the formal specification.

### CONCLUSION

The foregoing description provides an enabling disclosure of a domain-bound behavioral economic identity terminal system with ActionLedger, DomainTalk, Permission Tree, TrustNet, and Offline Mesh Synchronization. The invention is not limited to the examples disclosed. Variations in programming language, database form, signature scheme, domain naming system, secure storage technology, device form factor, cloud or edge deployment, quorum threshold, reconciliation rule, or industry-specific terminal type are within the scope of the invention when the terminal performs the claimed identity generation, signed record storage, domain-terminal binding, permission tree execution, offline vault caching, and mesh synchronization functions.

### Additional Implementation Details

### Implementation Detail Group 1

In mobile terminals, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The mobile terminals implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a mobile terminals terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The mobile terminals implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 2

In hosted domain endpoints, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The hosted domain endpoints implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a hosted domain endpoints terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The hosted domain endpoints implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 3

In edge containers, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The edge containers implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a edge containers terminal operates offline, it may restrict write operations to local rules, emergency rules, or pre-authorized templates. It may store provisional records and peer receipts in the Offline Trust Vault, mark records with conflict flags, and reconcile later using the always-online server to approve each local action.

The edge containers implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 4

In wallet endpoints, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The wallet endpoints implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a wallet endpoints terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The wallet endpoints implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 5

In AI-agent endpoints, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The AI-agent endpoints implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a AI-agent endpoints terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The AI-agent endpoints implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 6

In medical nodes, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The medical nodes implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a medical nodes terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The medical nodes implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 7

In financial nodes, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The financial nodes implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a financial nodes terminal operates offline, it may restrict write operations to local rules, emergency rules, or pre-authorized templates. It may store provisional records and peer receipts in the Offline Trust Vault, mark records with conflict flags, and reconcile later using the always-online server to approve each local action.

The financial nodes implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 8

In education nodes, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The education nodes implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a education nodes terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The education nodes implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 9

In family clusters, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The family clusters implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a family clusters terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The family clusters implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 10

In registry nodes, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The registry nodes implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a registry nodes terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The registry nodes implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 11

In service provider gateways, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The service provider gateways implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a service provider gateways terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The service provider gateways implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Implementation Detail Group 12

In local ad-hoc mesh nodes, the terminal may use the same ordered state path while adapting storage, network transport, and verification rules to local requirements. The terminal may store signed records locally, publish route metadata through a domain endpoint, and exchange compact state packages with selected remote nodes. The implementation may use public-key signatures, threshold signatures, hardware-backed keys, certificate chains, secure enclaves, or HSM-backed keys to preserve verifiability.

The local ad-hoc mesh nodes implementation may define service-specific event types, permission scopes, and privacy levels. The event types may include login, service request, role grant, role revocation, emergency access, recovery request, domain transfer, transaction approval, medical consent, credential issuance, AI instruction, registry operation, or dispute submission. Each event can be signed, stored, compared, routed, and reconciled using the same terminal state objects.

When a local ad-hoc mesh nodes terminal operates offline, it may restrict write operations to local rules, emergency rules, or pre-authorized templates. It may store provisional records and peer receipts in the Offline Trust Vault, mark records with conflict flags, and reconcile later using the deterministic rule set. The implementation therefore remains robust without requiring a single always-online server to approve each local action.

The local ad-hoc mesh nodes implementation also supports anti-circumvention coverage because the protective scope is tied to the functional relationship among behavioral identity, signed ledger records, domain-based addressing, permission-tree state, privacy records, recovery records, and mesh synchronization. A different vocabulary, user interface, or hosting arrangement does not remove that technical relationship.

### Supplemental Non-Repetitive Enablement and Cross-Layer Support

The following supplemental disclosure expands the specification with non-repetitive technical implementation detail. It adds formulas, pseudocode, data structures, protocol messages, vertical embodiments, anti-circumvention language, and claim-support mapping while preserving the same BEI terminal core and avoiding filler or repeated implementation clusters.

### Additional Enablement—Specific Bei Vector Computation

In one implementation, the BEI behavioral economic identity vector is computed from a set of normalized terminal event features. Each feature is produced from a signed behavioral event record and is therefore linked to a terminal identifier, domain identifier, timestamp, event type, permission state, and verification value. The BEI vector may include separate components for terminal interaction, permission invocation, service performance, transaction routing, recovery history, dispute outcome, peer attestation, and synchronization reliability.

A non-limiting vector update may be expressed as T_new=alpha*T_old+ (1−alpha)*SUM(w_i*F_i(x_i)*EXP (−lambda*delta_t_i)), where T_old is a prior trust weight, alpha is a smoothing coefficient, w_i is a feature weight, F_i is a feature normalization function, delta_t_i is event age, and lambda is a decay coefficient. This equation is not claimed as a pure mathematical result. It is one implementation of a terminal state update performed after the terminal receives a signed event and before the permission tree, ActionLedger, and TrustNet state are updated.

The terminal may implement feature normalization by converting raw local events into bounded values. For example, a verified service completion event may produce a positive service quality value, a disputed permission invocation may produce a negative dispute value until resolved, a peer receipt may increase a synchronization reliability value, and an expired event may carry a lower weight than a recent event. The resulting vector is used by the terminal to make routing, access, recovery, and synchronization decisions.

```
function UPDATE_BEI_VECTOR(event_record, prior_vector):
  assert verify_signature(event_record.signature,
  event_record.terminal_id)
  features = extract_features(event_record)
  for each feature in features:
    normalized = normalize(feature.value, feature.policy)
    decay = exp(−lambda(feature.type) * age(feature.timestamp)
      prior_vector[feature.slot] = alpha * prior_vector[feature.slot] +
      (1−alpha) *
normalized * decay
  prior_vector.behavior_history_hash =
  hash(prior_vector.behavior_history_hash ||
event_record.record_hash)
  return sign_vector(prior_vector)
```

### Additional Enablement—Actionledger Construction and Verification

The ActionLedger may be implemented as a hash-linked event store, Merkle tree, radix tree, directed acyclic graph, append-only database, local cache-ledger, distributed ledger, or equivalent verifiable state structure. The selected structure is not critical if the terminal can preserve ordering, verify record integrity, compare prior and current permission states, and detect conflicts between local and remote state packages.

In one implementation, each ActionLedger entry contains a parent hash, event payload hash, permission payload hash, signature, ledger-state hash, synchronization epoch, and conflict flag. The parent hash preserves ordering. The event payload hash binds the entry to the behavioral event. The permission payload hash binds the entry to a particular before-and-after access state. The ledger-state hash allows a remote terminal to compare a compact digest without receiving all raw behavioral evidence.

The ActionLedger is also used to generate a dispute evidence package. If two terminals disagree about a permission state, the relevant signed entries, hashes, timestamps, role states, trust-score deltas, and domain-terminal mapping records may be packaged and submitted to a consensus verification node, registry dispute node, family recovery node, or institutional review node. This makes the ledger a technical evidence substrate rather than a mere audit label.

```
function APPEND_ACTION_LEDGER(record, ledger_state):
  record.parent_hash = ledger_state.current_hash
  record.event_payload_hash = hash(record.event_payload)
  record.permission_payload_hash = hash(record.prior_permission ||
record.current_permission)
  record.signature = sign(record, terminal_private_key)
  record.ledger_state_hash = hash(record.parent_hash
  || record.event_payload_hash ||
record.permission_payload_hash || record.signature)
  ledger_state.current_hash = record.ledger_state_hash
  ledger_state.sequence += 1
  return record
```

### Additional Enablement—Domaintalk Binding and Adaptive Routing

DomainTalk or the domain-terminal mapping module may validate domain control through DNS proof, registry proof, certificate proof, wallet signature, decentralized namespace proof, institutional authorization, or another machine-verifiable authority record. After validation, the terminal creates a signed domain-terminal binding record that associates the domain label with a terminal identifier, BEI vector reference, controller role, routing policy, service pointer, audit endpoint, recovery endpoint, synchronization endpoint, key identifier, and validity metadata.

Adaptive name routing allows a persistent BEI domain address to continue operating when the physical endpoint changes. A mobile terminal may move between networks, a hosted container may migrate between cloud regions, or a recovery node may temporarily replace a lost endpoint. The mapping record preserves the relationship among BEI identity state, domain control, permission rules, and routing state so that service requests are not routed merely on the basis of an IP address.

The domain-terminal binding also supports anti-circumvention coverage. A competing system may substitute a decentralized identifier, registry handle, URL, subdomain, wallet name, or service name for a conventional domain. If the name is used to bind terminal identity and permission state to a routable endpoint, the implementation remains structurally equivalent to the disclosed domain-terminal mapping path.

```
function BIND_DOMAIN(domain_label, terminal_id, bei_vector_ref):
  proof = request_domain_control_proof(domain_label)
  if not verify_domain_proof(proof): reject_binding( )
  binding = {domain_label, terminal_id,
  bei_vector_ref, controller_role, routing_policy,
service_pointer, audit_endpoint, recovery_endpoint}
    binding.signature = sign(binding, terminal_private_key)
  write_to_actionledger(binding)
  publish_service_pointer(binding)
  return binding
```

### Additional Enablement—Permission Tree Execution

The permission tree may be represented as a hierarchical tree, graph, policy table, capability chain, or rule set. A permission node may include subject, object, action, access scope, role, inheritance condition, delegation condition, revocation condition, recovery condition, emergency override condition, validity window, trust threshold, privacy requirement, service endpoint, and rollback rule. The terminal evaluates these values when a user, wallet, AI agent, family node, medical node, financial node, educational node, service provider, or registry node requests an action.

A parent-child permission relationship can represent individual-to-family, family-to-institution, institution-to-service-provider, user-to-AI-agent, patient-to-medical-provider, wallet-to-financial-service, or domain-owner-to-registry relationships. The terminal can store the state before and after a permission update and can use the ActionLedger to reconstruct a history of delegation, inheritance, revocation, and recovery events.

The permission tree supports temporary override without abandoning auditability. When an emergency condition is detected, the terminal may grant a limited access scope for a fixed time window, record the override as a signed ActionLedger entry, and require TrustNet reconciliation after reconnection. This path protects medical and disaster-recovery use cases while preventing permanent silent privilege escalation.

```
function EVALUATE_PERMISSION(request, permission_tree, bei_vector):
  node = find_best_matching_node(permission_tree, request.subject, request.object,
request.action)
  if node is None: return DENY_WITH_RECEIPT(request, reason=“no_matching_rule”)
  if bei_vector.trust_weight < node.trust_threshold: return
DENY_WITH_RECEIPT(request, reason=“trust_threshold”)
  if not within_validity_window(node, request.timestamp): return
DENY_WITH_RECEIPT(request, reason=“expired”)
  if node.requires_privacy_proof: verify_privacy_sidecar(request.proof)
  decision = ALLOW_SCOPE(node.access_scope)
  write_permission_decision_to_actionledger(request, node, decision)
  return decision
```

### Additional Enablement—Offline Trust Vault and Deterministic Reconciliation

The offline trust vault stores signed records, ledger hashes, local signatures, peer receipts, quorum metadata, service requests, local permission decisions, state hashes, and conflict flags during a disconnected state. The vault is not merely file storage. It is a structured terminal state container that preserves evidence for later verification and deterministic reconciliation. A vault package may be encrypted at rest and may include a hardware-backed key reference or secure enclave reference when available.

When connectivity resumes, the synchronization module exchanges vault packages with selected remote nodes. The module verifies signatures, compares ledger-state hashes, checks timestamp windows, validates quorum metadata, applies CRDT merge rules to non-conflicting state fields, and resolves remaining conflicts according to trust-weight, domain-priority, permission-priority, or emergency-priority rules. The reconciliation result is itself stored as an ActionLedger entry.

This technical pathway addresses a concrete distributed-computing problem: a terminal may continue local execution during a network partition without losing verifiability or allowing unbounded local divergence. The terminal does not simply wait for a server. It produces signed provisional state and later merges that state under deterministic rules.

```
function RECONCILE_VAULT(local_vault, remote_state):
vverify_all_signatures(local_vault.cached_records)
  compare(local_vault.ledger_hash, remote_state.ledger_hash)
  classify_conflicts(local_vault.cached_records, remote_state.records)
  apply_crdt_merge(non_conflicting_records)
  for each conflict in conflicts:
    resolve_by(timestamp, signature_validity,
    quorum, trust_weight, domain_priority,
permission_priority)
  outcome = create_reconciliation_record(local_vault,
  remote_state, resolved_state)
  append_to_actionledger(outcome)
  return resolved_state
```

### Specific Data Structures—Expanded Field-Level Support

### Data Structure—BEI Behavioral Event Record

A BEI Behavioral Event Record may include event identifier, source terminal, target terminal, domain identifier, actor role, event class, event type, timestamp, terminal input/output digest, hardware interaction digest, network route digest, service context, prior permission state, current permission state, signature, verification value, trust delta, privacy flag, dispute flag, and synchronization epoch. The listed fields are examples and may be encoded as JSON, binary records, relational rows, graph nodes, signed messages, certificates, ledger entries, domain registry-linked records, or other machine-readable structures.

The purpose of the BEI Behavioral Event Record is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—BEI Vector State

A BEI Vector State may include identity seed, terminal public identifier, domain-bound identity value, behavior history hash, role state, trust weight, service quality digest, permission status, recovery state, privacy mode flag, dispute history reference, and vector signature. The listed fields are examples and may be encoded as JSON, binary records, relational rows, graph nodes, signed messages, certificates, ledger entries, domain registry-linked records, or other machine-readable structures.

The purpose of the BEI Vector State is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—BEI Domain Binding Record

A BEI Domain Binding Record may include domain label, namespace type, terminal identifier, BEI reference, controller role, routing policy, service pointer, registry pointer, audit endpoint, recovery endpoint, synchronization endpoint, key identifier, validity interval, transfer status, and binding signature. The listed fields are examples and may be encoded as JSON, binary records, relational rows, graph nodes, signed messages, certificates, ledger entries, domain registry-linked records, or other machine-readable structures.

The purpose of the BEI Domain Binding Record is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—Permission Tree Node

A Permission Tree Node may include node identifier, parent node, child node, subject class, object class, action class, role, scope, delegation rule, inheritance rule, revocation rule, emergency rule, recovery rule, trust threshold, privacy requirement, time window, and rollback condition. The listed fields are examples and may be encoded as JSON, binary records, relational rows, graph nodes, signed messages, certificates, ledger entries, domain registry-linked records, or other machine-readable structures.

The purpose of the Permission Tree Node is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—Offline Vault Package

A Offline Vault Package may include vault identifier, terminal identifier, start time, end time, cached ledger records, local ledger hash, local signatures, peer receipts, local quorum, provisional state marker, conflict flags, encrypted evidence reference, and reconciliation status. The listed fields are examples and may be encoded as JSON, binary records, relational rows, graph nodes, signed messages, certificates, ledger entries, domain registry-linked records, or other machine-readable structures.

The purpose of the Offline Vault Package is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—Terminal State Package

A Terminal State Package may include BEI vector digest, permission tree digest, ledger-state hash, domain binding state, synchronization status, trust-score delta, vault reference, privacy sidecar digest, recovery state, and reconciliation metadata. The listed fields are examples and may be encoded as JSON, binary records, relational rows, graph nodes, signed messages, certificates, ledger entries, domain registry-linked records, or other machine-readable structures.

The purpose of the Terminal State Package is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—Dispute Evidence Package

A Dispute Evidence Package may include dispute identifier, claimant terminal, respondent terminal, challenged event, signed record references, timestamp list, permission-state changes, role-state changes, domain mapping records, trust-history references, selected evidence, privacy proof reference, requested outcome, and result record. The listed fields are examples and may be encoded as JSON, binary records, relational rows, graph nodes, signed messages, certificates, ledger entries, domain registry-linked records, or other machine-readable structures.

The purpose of the Dispute Evidence Package is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—Privacy Sidecar Record

A Privacy Sidecar Record may include public digest, encrypted private evidence, consent node, disclosure level, expiry, proof type, verification key reference, policy reference, service context, and revocation state. The listed fields are examples and may be encoded as JSON, binary records, relational rows, graph nodes, signed messages, certificates, ledger entries, domain registry-linked records, or other machine-readable structures.

The purpose of the Privacy Sidecar Record is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—Machine-Readable Credential

A Machine-Readable Credential may include credential identifier, subject terminal, issuer terminal, service endpoint, role scope, allowed action, validity window, privacy mode, revocation condition, domain binding reference, and issuer signature. The listed fields are examples and may be encoded as JSON, binary records, relational rows, graph nodes, signed messages, certificates, ledger entries, domain registry-linked records, or other machine-readable structures.

The purpose of the Machine-Readable Credential is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Data Structure—Participation Value Record

A Participation Value Record may include terminal identifier, event window, time-bound contribution, consensus participation value, service quality value, validation status, trust weight before, trust weight after, governance utility value, expiration condition, and allocation signature. The listed fields are examples and may be encoded as JSON, binary records, relational rows, graph nodes, signed messages, certificates, ledger entries, domain registry-linked records, or other machine-readable structures.

The purpose of the Participation Value Record is to maintain a verifiable relationship among BEI behavioral identity state, ActionLedger record state, domain-terminal mapping state, permission tree state, offline vault state, and TrustNet synchronization state. The terminal may store the structure locally, transmit a digest, disclose a proof, or keep raw private evidence encrypted under the privacy mode.

### Protocol Message Examples

### Protocol Message—TerminalRegistrationRequest

TerminalRegistrationRequest may include the following fields: domain_label, terminal_identifier, public_key_reference, BEI_seed, service_endpoint, recovery_endpoint, timestamp, signature. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Protocol Message—BehavioralEventMessage

BehavioralEventMessage may include the following fields: event_identifier, actor_terminal, target_terminal, domain_identifier, event_type, timestamp, prior_permission_state, modified_permission_state, evidence_digest, signature. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Protocol Message—PermissionUpdateMessage

PermissionUpdateMessage may include the following fields: permission_node, parent_node, child_node, role_scope, delegation_rule, revocation_rule, validity_window, ledger_reference, signature. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Protocol Message—Offline VaultMessage

Offline VaultMessage may include the following fields: vault_identifier, terminal_identifier, disconnected_start, disconnected_end, cached_record_digest, state_hash, peer_receipt_list, conflict_flag, signature. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Protocol Message—ReconciliationMessage

ReconciliationMessage may include the following fields: source_terminal, target_terminal, vault_reference, delta_summary, timestamp_rule, quorum_rule, trust priority_value, reconciliation_outcome. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Protocol Message—DomainTransferMessage

Domain TransferMessage may include the following fields: prior_domain_terminal, new_domain_terminal, transfer_condition, recovery_proof, key_rotation_state, permission_tree_update, ledger_reference, signature. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Protocol Message—CredentialIssueMessage

CredentialIssueMessage may include the following fields: credential_identifier, subject_terminal, issuer_terminal, role_scope, service_endpoint, validity_window, privacy_mode, revocation_condition, signature. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Protocol Message—EmergencyOverrideMessage

EmergencyOverrideMessage may include the following fields: override_identifier, triggering_condition, authorized_terminal, scope_of_access, expiration_time, audit_requirement, reconciliation_requirement, signature. The message may be represented as a signed object, binary message, credential payload, database record, ledger entry, or other machine-readable structure. A receiving terminal may validate the message against the BEI vector, ActionLedger state, domain binding state, permission tree, and TrustNet synchronization state before accepting or propagating it.

### Detailed Embodiments by Terminal Class

### Embodiment—Personal BEI Terminal

The personal BEI terminal stores user-specific roles, consent rules, service pointers, wallet permissions, local recovery rules, privacy sidecar policies, and ActionLedger entries. A service request addressed to the personal BEI domain is evaluated against a live vector rather than a static account credential. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Family BEI Inheritance Terminal

The family BEI terminal uses a root family domain, child terminal records, guardian rules, heir rules, emergency medical rules, and inheritance triggers. The terminal records each delegation and revocation so that later succession or dispute review can reconstruct the complete permission history. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Community BEI Mesh Terminal

The community BEI terminal supports local projects, school nodes, neighborhood nodes, municipal nodes, local quorum, offline records, and geo-federated routing. It can continue limited governance during disaster mode and later merge vault records through TrustNet. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Institutional BEI Access Terminal

The institutional BEI terminal issues role-scoped credentials and service access approvals to user terminals. It can accept privacy-preserving proof instead of raw behavior records and can write a signed service receipt for audit and dispute purposes. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—AI-Agent BEI Authority Terminal

The AI-agent BEI terminal receives a machine-readable credential describing permitted actions, service endpoints, validity windows, revocation conditions, privacy limits, and audit obligations. AI-agent instructions can be routed through the permission tree and recorded as signed ActionLedger events. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Wallet BEI Authorization Terminal

The wallet BEI terminal evaluates transaction requests, spending scopes, recovery delegates, service provider roles, and trust thresholds. It can deny a wallet instruction when the BEI vector, domain state, or permission node does not authorize the requested action. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Medical BEI Consent Terminal

The medical BEI terminal enforces patient consent, emergency override, family recovery, physician role, limited clinical access, and post-event reconciliation. Emergency access can be allowed temporarily but must be recorded and later reconciled. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Financial BEI Trust Terminal

The financial BEI terminal supports onboarding, risk-tiered service access, transaction approval, dispute evidence, wallet credential issuance, and service-quality feedback. Trust scores may affect routing or review thresholds without disclosing raw private evidence. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Educational BEI Credential Terminal

The educational BEI terminal issues learning credentials, program access rights, instructor roles, family access controls, and time-bound permissions. Completion events can be signed and recorded to support later verification. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Domain Registry BEI Terminal

The registry BEI terminal binds domain names, subdomains, registry handles, namespace identifiers, transfer records, and recovery endpoints to terminal identifiers and BEI vector references. This gives domain assets an executable terminal identity and permission state. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Disaster Recovery BEI Terminal

The disaster recovery BEI terminal operates with local ad-hoc communication, local quorum receipts, cache-ledger storage, emergency override, and delayed reconciliation. It is designed to sustain critical access when cloud or central services fail. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Embodiment—Cross-Domain BEI Bridge Terminal

The cross-domain bridge translates policy and permission states between different domains, institutions, or jurisdictions while preserving signed relationships among BEI identity, ActionLedger records, domain mapping, and TrustNet state. The embodiment uses the same ordered terminal stack: behavioral event capture, BEI vector update, signed ActionLedger entry, domain mapping, permission tree evaluation, service routing, privacy processing, and TrustNet synchronization. The embodiment is not limited to a single blockchain, database, programming language, hardware vendor, or commercial naming convention.

In operation, the terminal initializes a terminal identifier, binds the identifier to a domain-based address, loads or creates an initial permission tree, records an initial ledger-state hash, and publishes a service or recovery pointer. Subsequent events are signed, evaluated, and synchronized according to terminal rules. When disconnected, the terminal caches signed state and later reconciles it under deterministic rules.

### Pseudocode for Representative Terminal Flows

### Flow—Terminal Initialization

The Terminal Initialization flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function TERMINAL_INITIALIZATION( ):
  create terminal_identifier
    generate key pair or secure enclave key reference
  create BEI identity seed
    bind domain address
  create initial permission tree
    initialize ActionLedger state
    publish service and recovery endpoints
  create terminal state package
  return signed_terminal_state
```

### Flow—Behavioral Event Processing

The Behavioral Event Processing flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function BEHAVIORAL_EVENT_PROCESSING( ):
  receive event
    verify source and timestamp
    extract event features
    update BEI vector
  create signed ActionLedger record
    update permission state if required
  create service routing decision
  send or cache terminal state package
  return signed_terminal_state
```

### Flow—Permission Delegation

The Permission Delegation flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function PERMISSION_DELEGATION( ):
    locate parent permission node
    verify delegator role
  create child scope
    apply validity window and revocation condition
    write signed permission update
    issue machine-readable credential if required
    synchronize update
  return signed_terminal_state
```

### Flow—Family Inheritance Trigger

The Family Inheritance Trigger flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function FAMILY_INHERITANCE_TRIGGER( ):
  detect verified life event or scheduled inheritance trigger
    validate successor terminal
  rotate or update recovery keys
    move or copy scoped rights
    record before-and-after state
  notify family recovery nodes
  reconcile with registry node
  return signed_terminal_state
```

### Flow—Emergency Medical Override

The Emergency Medical Override flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function EMERGENCY_MEDICAL_OVERRIDE( ):
  detect emergency condition
  select limited medical access scope
    verify authorized emergency requester
  grant temporary access
    record override event
  set expiration and reconciliation requirement
  revoke or review after emergency ends
  return signed_terminal_state
```

### Flow—Offline Operation

The Offline Operation flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function OFFLINE_OPERATION( ):
  detect network partition
  enter offline mode
  cache signed records in vault
    enforce local permission subset
  collect peer receipts if nearby peers exist
  mark records provisional
  prepare vault package for reconnection
  return signed_terminal_state
```

### Flow—TrustNet Reconciliation

The TrustNet Reconciliation flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function TRUSTNET_RECONCILIATION( ):
  exchange vault packages
    verify signatures
    compare ledger hashes
    classify conflicts
    apply CRDT to mergeable fields
    resolve remaining conflicts by timestamp,
    quorum, trust weight, domain priority, and
permission priority
    write reconciliation record
  return signed_terminal_state
```

### Flow—Privacy Sidecar Verification

The Privacy Sidecar Verification flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function PRIVACY_SIDECAR_VERIFICATION( ):
  separate public digest from private evidence
  encrypt raw behavioral evidence
  produce verification proof
  release proof under consent and service scope
    record disclosure decision
  expire proof according to policy
  return signed_terminal_state
```

### Flow—Domain Transfer and Recovery

The Domain Transfer and Recovery flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function DOMAIN_TRANSFER_AND_RECOVERY( ):
  receive domain transfer request
    verify control or recovery proof
  rotate keys
    update domain binding record
    update permission tree root if required
    record transfer event
    publish new endpoint
  return signed_terminal_state
```

### Flow—AI-Agent Credential Issue

The AI-Agent Credential Issue flow is a non-limiting example of executable terminal logic. Each step may be performed locally, by a hosted terminal service, by an edge node, by a wallet application, by a registry endpoint, or by a hybrid terminal deployment, provided that signed state relationships are preserved.

```
function AI-AGENT_CREDENTIAL_ISSUE( ):
  receive AI-agent authorization request
    evaluate human or institutional permission node
  create machine-readable credential
  set role scope and action limit
    record credential issuance
  monitor and revoke on violation
  return signed_terminal_state
```

### Anti-Circumvention and Equivalent Implementations

### Anti-Circumvention—Renaming BEI-ID

A competing implementation may avoid the term BEI-ID and call the same data a behavior score, identity vector, reputation vector, trust state, terminal profile, or dynamic credential. If the implementation generates a behavior-updated identity state from signed terminal events and uses it for permissions or routing, it follows the disclosed technical path. This description is provided to define structural and functional equivalence without requiring any proprietary label, business terminology, or single vendor architecture.

### Anti-Circumvention—Replacing ActionLedger Terminology

A system may call the ActionLedger an audit log, state log, receipt store, activity ledger, event journal, or transaction log. If it stores signed behavioral event records that affect trust, permission, evidence, or synchronization state, it remains structurally equivalent. This description is provided to define structural and functional equivalence without requiring any proprietary label, business terminology, or single vendor architecture.

### Anti-Circumvention—Substituting Namespace for Domain

A system may use decentralized identifiers, registry handles, subdomains, URLs, wallet names, service names, or application-specific namespaces instead of DNS names. If the name is bound to a terminal identifier and controls routing or permission state, it is an equivalent domain-terminal mapping. This description is provided to define structural and functional equivalence without requiring any proprietary label, business terminology, or single vendor architecture.

### Anti-Circumvention—Central Server Substitution

A central server can store identity or permission information, but it does not provide the same local terminal continuity, offline trust vault, signed provisional state, and deterministic mesh reconciliation unless it implements the disclosed terminal state path. This description is provided to define structural and functional equivalence without requiring any proprietary label, business terminology, or single vendor architecture.

### Anti-Circumvention—Pure Blockchain DAO Substitution

A blockchain-only DAO may record votes or transactions, but without terminal-level behavioral identity, domain mapping, permission tree execution, privacy sidecar, and offline reconciliation, it lacks the disclosed integrated terminal operation. This description is provided to define structural and functional equivalence without requiring any proprietary label, business terminology, or single vendor architecture.

### Anti-Circumvention—Pure Wallet Substitution

A wallet may store keys and tokens, but without BEI vector updates, signed behavioral event records, domain-bound routing, permission inheritance, and TrustNet reconciliation, it does not implement the disclosed terminal system. This description is provided to define structural and functional equivalence without requiring any proprietary label, business terminology, or single vendor architecture.

### Anti-Circumvention—Offline Storage Substitution

Offline storage alone caches files. The disclosed offline trust vault caches signed governance events, permission state, ledger hashes, trust values, peer receipts, and reconciliation metadata for later mesh validation. This description is provided to define structural and functional equivalence without requiring any proprietary label, business terminology, or single vendor architecture.

### Anti-Circumvention—Token-Only Incentive Substitution

A token reward system may record incentives. The disclosed participation value is tied to signed behavioral records, terminal state, permission logic, and domain-linked routing state, and therefore operates as part of the terminal state machine. This description is provided to define structural and functional equivalence without requiring any proprietary label, business terminology, or single vendor architecture.

### Anti-Circumvention—Hardware-Only Authentication Substitution

A secure device may prove possession, but the disclosed system combines secure execution with behavioral state, ActionLedger records, domain-terminal mapping, permission tree, recovery, and TrustNet synchronization. This description is provided to define structural and functional equivalence without requiring any proprietary label, business terminology, or single vendor architecture.

### Anti-Circumvention—AI Agent Gateway Substitution

An AI platform may issue API tokens to agents. The disclosed terminal issues machine-readable credentials tied to BEI identity state, permission tree scope, domain routing, service endpoint, revocation condition, and ledger evidence. This description is provided to define structural and functional equivalence without requiring any proprietary label, business terminology, or single vendor architecture.

### Support for Claims and Cross-Layer Protection

### Claim Support—Claim 1

Claim 1 is supported by the integrated terminal system containing programmable sovereign terminals, BEI behavioral identity generation, ActionLedger signed event storage, domain-terminal mapping, permission tree execution, and TrustNet synchronization. The specification describes structural modules, representative fields, processing flows, and examples so that one of ordinary skill can implement the claimed subject matter across hardware, software, hosted, edge, wallet, AI-agent, domain-registry, medical, financial, educational, and hybrid deployments.

### Claim Support—Claim 2

Claim 2 is supported by the method flow in which the terminal receives an event, generates a BEI vector, creates a signed record, stores the record, binds terminal identity to a domain address, updates permissions, routes a service request, and synchronizes state. The specification describes structural modules, representative fields, processing flows, and examples so that one of ordinary skill can implement the claimed subject matter across hardware, software, hosted, edge, wallet, AI-agent, domain-registry, medical, financial, educational, and hybrid deployments.

### Claim Support—Claim 3

Claim 3 is supported by non-transitory computer-readable instructions that cause a terminal device to perform the identity, ledger, domain binding, permission, offline vault, synchronization, and service-routing operations. The specification describes structural modules, representative fields, processing flows, and examples so that one of ordinary skill can implement the claimed subject matter across hardware, software, hosted, edge, wallet, AI-agent, domain-registry, medical, financial, educational, and hybrid deployments.

### Claim Support—Claims 4-9

claims 4-9 are supported by the expanded BEI vector, adaptive routing, parent-child permission relationships, verifiable data structures, offline vault reconciliation, and emergency override sections. The specification describes structural modules, representative fields, processing flows, and examples so that one of ordinary skill can implement the claimed subject matter across hardware, software, hosted, edge, wallet, AI-agent, domain-registry, medical, financial, educational, and hybrid deployments.

### Claim Support—Claims 10-15

claims 10-15 are supported by domain validation, role assignment, dispute evidence generation, consensus review, key rotation, and privacy sidecar sections. The specification describes structural modules, representative fields, processing flows, and examples so that one of ordinary skill can implement the claimed subject matter across hardware, software, hosted, edge, wallet, AI-agent, domain-registry, medical, financial, educational, and hybrid deployments. Claim Support—Claims 16-20

claims 16-20 are supported by terminal state packages, machine-readable credential issuance, participation value updates, geo-federated/ad-hoc mesh exchange, and emergency override reconciliation sections. The specification describes structural modules, representative fields, processing flows, and examples so that one of ordinary skill can implement the claimed subject matter across hardware, software, hosted, edge, wallet, AI-agent, domain-registry, medical, financial, educational, and hybrid deployments.

### Additional Technical Advantages

### Technical Advantage—Computer Function Improvement

The terminal provides computer function improvement by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Reduced Central Dependency

The terminal provides reduced central dependency by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Domain-Level Portability

The terminal provides domain-level portability by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Behavioral Accountability

The terminal provides behavioral accountability by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Inheritance and Delegation Continuity

The terminal provides inheritance and delegation continuity by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Privacy-Preserving Proof

The terminal provides privacy-preserving proof by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Offline Resilience

The terminal provides offline resilience by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Ai-Agent And Wallet Interoperability

The terminal provides AI-agent and wallet interoperability by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Registry And Registrar Integration

The terminal provides registry and registrar integration by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Dispute Evidence Continuity

The terminal provides dispute evidence continuity by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Key Rotation And Recovery Continuity

The terminal provides key rotation and recovery continuity by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Service Routing Certainty

The terminal provides service routing certainty by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Cross-Domain Policy Translation

The terminal provides cross-domain policy translation by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Disaster-Mode Local Operation

The terminal provides disaster-mode local operation by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Machine-Readable Credential Portability

The terminal provides machine-readable credential portability by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

### Technical Advantage—Geo-Federated Synchronization Efficiency

The terminal provides geo-federated synchronization efficiency by integrating BEI identity state, ActionLedger record state, domain-terminal address state, permission tree state, privacy state, recovery state, and TrustNet synchronization state at the terminal level. A system that lacks one of these relationships may perform a partial function, but it does not provide the same verifiable state machine capable of operating during disconnection and reconciling signed state packages after reconnection.

Commercially Relevant Deployment Channels without Limiting the Claims

### Deployment Channel—BEI Domain Assets

A domain asset may be converted from a passive name into an executable terminal endpoint by binding the domain to BEI identity, permission state, service routing, recovery, and synchronization. This deployment channel supports asset packaging and licensing value because it shows how the same claimed terminal architecture can be practiced in multiple industries while retaining a common technical core. The claims are not limited to the commercial examples unless expressly recited.

### Deployment Channel—BEI TimeCurrency and Time of Time

Time-bound participation values may be generated from signed behavioral records and may support service priority, governance utility, or proof of contribution without requiring any particular currency architecture. This deployment channel supports asset packaging and licensing value because it shows how the same claimed terminal architecture can be practiced in multiple industries while retaining a common technical core. The claims are not limited to the commercial examples unless expressly recited.

### Deployment Channel—BEI MedicalCenter and Health Nodes

Medical nodes may use emergency override, patient consent, family recovery, privacy sidecar records, and audit logs to authorize limited access. This deployment channel supports asset packaging and licensing value because it shows how the same claimed terminal architecture can be practiced in multiple industries while retaining a common technical core. The claims are not limited to the commercial examples unless expressly recited.

### Deployment Channel—BEI ATMS and Asset-Time-Money Systems

Asset, time, monetary, and service interactions may be represented as behavioral events linked to terminal identity, domain address, permission state, and ledger evidence. This deployment channel supports asset packaging and licensing value because it shows how the same claimed terminal architecture can be practiced in multiple industries while retaining a common technical core. The claims are not limited to the commercial examples unless expressly recited.

### Deployment Channel—BEI AI-Agent Infrastructure

AI agents may receive scoped machine-readable credentials and may be controlled through permission tree nodes, ActionLedger records, and revocation conditions. This deployment channel supports asset packaging and licensing value because it shows how the same claimed terminal architecture can be practiced in multiple industries while retaining a common technical core. The claims are not limited to the commercial examples unless expressly recited.

### Deployment Channel—BEI Financial and Wallet Infrastructure

Wallet and financial terminals may use BEI trust values, domain routing, service authorization, and dispute evidence packages to support permissioned financial service interactions. This deployment channel supports asset packaging and licensing value because it shows how the same claimed terminal architecture can be practiced in multiple industries while retaining a common technical core. The claims are not limited to the commercial examples unless expressly recited.

### Deployment Channel—BEI Registry and Registrar Infrastructure

Registry terminals may bind domains, subdomains, handles, and decentralized namespace identifiers to terminal identifiers, key rotation records, recovery records, and service pointers. This deployment channel supports asset packaging and licensing value because it shows how the same claimed terminal architecture can be practiced in multiple industries while retaining a common technical core. The claims are not limited to the commercial examples unless expressly recited.

### Conclusion

The foregoing disclosure provides a detailed, enabling, and non-repetitive description of the domain-bound BEI behavioral economic identity terminal system. It supplies specific modules, data structures, algorithms, flows, pseudocode, anti-circumvention examples, vertical embodiments, and claim support. The technical core remains the ordered combination of BEI behavioral identity generation, ActionLedger signed event recording, DomainTalk domain-terminal mapping, Permission Tree execution, Offline Trust Vault caching, and TrustNet synchronization. This combination provides a stronger basis for examination, continuation planning, licensing, transfer, and asset packaging than a thin abstract governance description or a repetitive page-filling specification.

### Additional Non-Repetitive Technical Support for Section 101, 112, 102, and 103

### Section 101 Practical Application—Endpoint Architecture

The claimed BEI terminal architecture is tied to a specific endpoint state machine rather than to a result-oriented business idea. The state machine receives signed terminal events, computes a BEI vector, updates a ledger hash, evaluates a permission tree, routes or denies a service request, and synchronizes or caches state. These operations change the condition of a computing endpoint and provide a particular improvement to distributed identity and access control systems.

### Section 101 Practical Application—Network Partition Handling

Network partition handling is a technical problem in distributed computing because events may occur while nodes cannot communicate with a central coordinator or global ledger. The BEI Offline Trust Vault solves the problem by preserving signed provisional state, peer receipts, local quorum data, and conflict flags so that a later TrustNet merge can reconstruct a valid order of operations.

### Section 101 Practical Application—Domain Routing Improvement

The DomainTalk mapping transforms a static name into a routing and control interface. A BEI domain may resolve to a service endpoint, audit endpoint, recovery endpoint, AI-agent endpoint, wallet endpoint, or synchronization endpoint. The terminal uses the BEI vector and permission tree before routing, which produces a technical improvement over ordinary DNS resolution.

### Section 112 Enablement—Feature Extraction

The terminal may extract features from event records by identifying the event class, parsing the permission state, comparing service status, measuring event recency, verifying the signature, reading the domain binding, and determining whether a peer receipt or dispute outcome exists. Feature extraction may be implemented as deterministic parsing routines or as policy-driven transformation tables stored in terminal memory.

### Section 112 Enablement—Trust Decay

A trust decay routine may reduce the weight of older events while preserving a signed history. For example, a recent verified service event may have a larger effect than a stale event from a prior epoch, while a severe unresolved dispute may maintain an adverse effect until a reconciliation record is written. The decay routine is applied to machine-readable fields, not to a subjective opinion.

### Section 112 Enablement—CRDT Merge

A conflict-free replicated data type rule may be applied to fields that can be merged without semantic loss, including receipt sets, disclosed proof references, non-conflicting local notes, or independent terminal state counters. Fields involving exclusive authority, emergency access, domain transfer, or inheritance may require priority rules or quorum review rather than automatic merge.

### Section 112 Enablement—Quorum Selection

Quorum selection may use a defined node subset such as a family recovery node, registry node, institutional reviewer, geo-federated node group, or peer receipt group. The quorum threshold may be absolute, weighted by trust, limited by domain scope, or limited by service category. The threshold is stored in the policy record and can be verified during reconciliation.

### Section 112 Enablement—Privacy Proof

A privacy proof may be a digest, zero-knowledge-style proof, certificate, selective disclosure credential, encrypted sidecar reference, or signed statement that a permission state or trust category has been satisfied. The terminal can therefore permit a remote service to verify authorization without receiving the complete raw behavioral evidence.

### Section 112 Enablement—Key Rotation

Key rotation may be scheduled or triggered by role transition, domain transfer, inheritance event, compromised credential, terminal loss, or administrator instruction. The terminal records the prior key reference, new key reference, affected domain binding, affected permission tree node, continuity proof, and signature so that future synchronization does not treat the rotation as an identity break.

### Section 112 Enablement—Service Denial Receipts

A denial receipt may include the request identifier, terminal identifier, domain endpoint, selected permission node, denial reason, timestamp, and signature. By storing denial as well as approval, the terminal creates a complete action history and makes later disputes or compliance review technically reproducible.

### Section 102 and 103 Differentiation—Beyond Static Credentials

Static credential systems authenticate possession or membership, but they do not generate a BEI vector from signed behavioral events, bind the vector to a domain endpoint, execute permission inheritance, cache signed offline vault state, and reconcile that state through TrustNet. The ordered combination is materially different from a username, password, token, certificate, or biometric login.

### Section 102 and 103 Differentiation—Beyond Ordinary Blockchain

An ordinary blockchain may store transactions, but it does not by itself provide domain-terminal mapping, local permission tree execution, privacy sidecar separation, local offline vault operation, emergency override state, or adaptive domain routing. The BEI terminal can operate locally and use a ledger structure without being limited to a global chain.

### Section 102 and 103 Differentiation—Beyond Ordinary Wallets

A wallet may sign transactions, but the BEI terminal also maintains permission inheritance, recovery rules, family and institutional roles, service routing, domain binding, privacy proof, participation value, and TrustNet reconciliation. These additional relationships transform the endpoint into a governance and identity terminal rather than a key container. Section 102 and 103 Differentiation—Beyond Ordinary DNS

DNS and other naming systems map names to network resources. The BEI domain-terminal mapping binds a name to a behavioral identity vector, terminal identifier, permission tree, ActionLedger state, recovery endpoint, synchronization endpoint, and audit endpoint. The name participates in state control, not just resolution.

### Section 102 and 103 Differentiation—Beyond Central IAM

Central identity and access management platforms rely on server-side role directories. The BEI terminal preserves user, family, institutional, wallet, AI-agent, medical, financial, education, service provider, and registry permission state at an independently operable terminal endpoint that can continue operating offline and reconcile later.

### Expanded Vertical Implementation Examples

### BEI Patient-Medical Access Flow

A patient terminal may store normal consent, emergency consent, family representative roles, physician role credentials, treatment context, expiration windows, and reconciliation requirements. If a hospital node requests emergency access during a network outage, the patient terminal may grant a temporary access scope, record the emergency override, cache the event in the Offline Trust Vault, and require post-event TrustNet reconciliation.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### BEI Financial Wallet Approval Flow

A wallet terminal may receive a transaction request from a financial service node. The terminal checks the domain binding, BEI trust weight, spending role, recovery state, and permission tree scope. If the transaction exceeds the permitted scope, the terminal may require a family recovery node, institutional approval, or additional credential proof before signing or routing the transaction.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### BEI AI-Agent Instruction Flow

An AI-agent terminal may receive a machine-readable credential that limits actions to a defined service endpoint, time window, data type, budget, or role. Each AI instruction is treated as a behavioral event, recorded in the ActionLedger, and subject to revocation when the permission tree or privacy sidecar indicates that the action exceeds the authorized scope.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### BEI Education Credential Flow

An education terminal may issue credentials for course completion, instructor authorization, parent access, program participation, and time-bound exam access. The credential is bound to the BEI terminal state and domain address so that a verifier can confirm validity without requiring access to all raw learning records.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### BEI Domain Registry Transfer Flow

A registry terminal may receive a domain transfer request, validate controller role, verify recovery proof, rotate a key, update the domain-terminal binding record, update the permission tree root, and store a signed transfer entry. This prevents a domain transfer from silently severing identity and permission continuity.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### BEI Community Disaster Flow

A community terminal may detect that remote infrastructure is unavailable, switch to local ad-hoc mesh mode, collect peer receipts, enforce critical service rules, cache vault records, and later synchronize through a geo-federated node subset. The result is a machine-verifiable record of local decisions made during the disaster interval.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### BEI Service Provider Routing Flow

A service provider terminal may receive a request at a BEI domain endpoint, request proof of permission, verify a privacy sidecar, check service quality history, and write a signed service decision. The service provider need not own the user identity system; it interacts with a verifiable terminal state.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### BEI Family Recovery Flow

A family recovery node may be activated after a terminal loss, death, incapacity, or scheduled inheritance trigger. The terminal checks the inheritance rule, verifies guardian or heir credentials, rotates affected keys, updates the permission tree, and stores a recovery event record linked to the prior state.

This implementation uses the same cross-layer BEI protection: BEI vector, ActionLedger signed record, DomainTalk mapping, Permission Tree rule, Privacy Sidecar when needed, Offline Trust Vault when disconnected, and TrustNet synchronization when remote validation is available. A competitor cannot avoid the technical path merely by renaming the vertical service or substituting a different user interface.

### Additional Formula and Parameter Examples

### Trust Update Parameters

T_new may be calculated from T_old, event class weight, service quality value, recency decay, peer attestation value, dispute outcome, and synchronization reliability. The values may be stored as fixed point numbers, integers, categories, or signed encoded values; the invention does not require a floating point implementation.

### Routing Eligibility

Routing eligibility may be calculated as R=f(domain_validity, role_state, trust_threshold, privacy_mode, service_scope, emergency_flag). If R fails, the terminal may deny routing and store a signed denial receipt; if R passes, the terminal may route the request and store a signed service receipt.

### Reconciliation Priority

Reconciliation priority may be calculated from timestamp validity, signature validity, quorum count, trust weight, domain priority, emergency status, and permission priority. A deterministic priority value allows terminals to reach the same conflict resolution result from the same signed input data.

### Participation Value

A time-bound participation value may be generated from verified event duration, service contribution, consensus participation, trust quality, and dispute-free interval. The value may be used as a governance utility, service priority, or evidence of contribution and is not limited to a monetary token.

### Representative Secure Storage and Hardware Support

The terminal may use secure storage, a secure enclave, hardware security module, trusted execution environment, secure element, software key store, cloud key management service, multi-signature approval, threshold secret sharing, or certificate-backed key hierarchy. The secure storage protects signing keys, recovery keys, vault encryption keys, privacy sidecar keys, and domain binding credentials. The claims do not require a particular HSM vendor, but the specification supports implementations that include hardware-backed security where available.

In a hardware-backed deployment, BEI vector updates, ActionLedger signing, domain binding records, key rotation records, and emergency overrides may be signed using keys isolated from ordinary application memory. In a hosted or containerized deployment, equivalent security may be achieved using a cloud HSM, key management service, or hardened signing service associated with the terminal identifier. The technical requirement is preservation of verifiable terminal state and not a particular device brand.

Continuation and Asset Package Support without Claim Limitation

The disclosure supports later continuation or divisional claims directed to medical consent terminals, AI-agent authority terminals, wallet authorization terminals, domain registry terminals, offline disaster terminals, privacy sidecar verification, geo-federated indexing. participation value generation, family inheritance terminals, and service-provider routing terminals. These embodiments are described as technical implementations of the same BEI terminal stack and do not limit the presently claimed independent system, method, or computer-readable medium unless expressly recited.

The cross-layer protection arises because each vertical implementation reuses the same technical relationships among BEI identity state, signed ActionLedger records, DomainTalk mapping, Permission Tree execution, Offline Trust Vault caching, Privacy Sidecar verification, Recovery and Key Rotation, and TrustNet synchronization. This allows transaction, licensing, transfer, and asset packaging discussions to point to a common core while preserving specific implementation support for future claim sets.

### Additional High-Value Implementation Matrices

### Matrix A—BEI Terminal Inputs and Outputs

A BEI terminal may receive local input events, remote service requests, AI-agent instructions, wallet transaction requests, registry operations, medical consent requests, financial onboarding events, educational credential events, family recovery events, and community governance events. The terminal may output signed ActionLedger records, permission decisions, denial receipts, privacy proofs, credentials, service routing decisions, vault packages, dispute evidence packages, participation values, and reconciliation receipts. This matrix supports broad but enabled practice across different industries while retaining the same technical core.

### Matrix B—BEI Terminal Security Modes

A BEI terminal may operate in normal mode, privacy mode, emergency mode, recovery mode, offline mode, quarantine mode, dispute mode, and migration mode. In normal mode, the terminal evaluates requests against current BEI and permission state. In privacy mode, it releases proofs instead of raw evidence. In emergency mode, it grants temporary scoped permissions. In recovery mode, it rotates keys and preserves continuity. In offline mode, it caches signed records. In quarantine mode, it limits disputed records. In migration mode, it updates a domain binding and endpoint.

### Matrix C—BEI Role Classes

Role classes may include owner, controller, guardian, heir, delegate, institutional reviewer, medical provider, financial provider, educational issuer, registry operator, AI-agent executor, wallet signer, community validator, service provider, recovery node, and dispute node. Each role class may be represented as a permission tree node with access scope, validity window, trust threshold, privacy condition, revocation condition, and ledger recording requirement.

### Matrix D—BEI Evidence Preservation

Evidence preservation may include hashing raw evidence, signing event summaries, encrypting raw private records, writing proof references, preserving timestamps, storing prior and current permission states, attaching peer receipts, and retaining synchronization epochs. The evidence path allows later review without requiring the terminal to publicly disclose every raw behavioral event.

### Matrix E—BEI Continuity Under Transfer

A terminal transfer, domain transfer, device replacement, cloud migration, wallet migration, or AI-agent reassignment may preserve BEI continuity by generating a transfer record, rotating affected keys, updating service pointers, preserving prior ledger hashes, and requiring reconciliation signatures from selected nodes. This prevents a transfer from destroying the behavioral and permission history of the terminal.

### Matrix F—BEI Cross-Domain Policy Translation

Cross-domain policy translation may occur when a personal BEI terminal interacts with a medical domain, financial domain, education domain, registry domain, or community domain. The source terminal supplies a credential or proof. The receiving terminal maps that proof to a local policy rule. The result is recorded so that both domains preserve their own policy language while maintaining verifiable state continuity.

### Matrix G—BEI Ad-Hoc Local Mesh

A local mesh may be created over Bluetooth, Wi-Fi Direct, wired local network, local radio, or another near-field communication path. Nearby BEI terminals can exchange signed receipts, local hashes, provisional permission decisions, and emergency service records. The later TrustNet reconciliation does not require continuous global connectivity because the local receipts provide evidence of event occurrence and order.

### Matrix H—BEI Registry Integration

A registry integration may allow domain renewal, domain transfer, subdomain delegation, registry dispute review, name-service endpoint publication, and recovery endpoint publication to be treated as BEI events. This makes domain control part of the terminal state machine and allows a domain asset to carry verifiable identity, permission, recovery, and service routing status.

### Matrix I—BEI Machine-Readable Credential Lifecycle

Credential lifecycle includes issuance, presentation, verification, limitation, suspension, revocation, renewal, and archival. Each lifecycle step may create a signed record linked to the issuing terminal, subject terminal, domain endpoint, role scope, validity window, privacy mode, and permission tree node. This lifecycle supports AI agents, wallets, service providers, medical nodes, financial nodes, education nodes, and registry nodes.

### Matrix J—BEI Dispute and Appeal Logic

A dispute may be initiated by a user terminal, family node, institutional node, service provider, AI-agent terminal, wallet terminal, registry node, or consensus verification node. The dispute package identifies the challenged event, affected permission node, ledger references, domain mapping references, trust history, and requested outcome. An appeal may require additional quorum, higher domain priority, or institutional review, and the final result is recorded as a signed outcome entry.

SUPPLEMENTAL PSEUDOCODE - CROSS-
DOMAIN AND DISPUTE OPERATIONS

```
function CROSS_DOMAIN_REQUEST(source_terminal, target_domain,
requested_service):
  proof = source_terminal.create_privacy_preserving_proof(requested_service)
  binding = resolve_domain_terminal_binding(target_domain)
      policy = binding.terminal.permission_tree.select_rule(requested_service)
  if not verify_proof_against policy(proof, policy):
    return signed_denial_receipt(source_terminal, target_domain, requested_service)
  decision = route_service_request(binding.service_endpoint, proof, policy.scope)
  write_actionledger_entry(decision)
  return decision
function DISPUTE_REVIEW(dispute_package):
  verify_package_signatures(dispute_package)
  load_referenced_ledger_records(dispute_package.record_reference_list)
      compare_permission_before_after(dispute_package.permission_state_references)
      evaluate_trust_history(dispute_package.trust_history_references)
      select_consensus_nodes(dispute_package.domain_mapping_reference)
  outcome = apply_consensus_policy(dispute_package, selected_nodes)
  append_actionledger_outcome(outcome)
  update_permission_tree_if_required(outcome)
  return outcome
```

### Final Technical Summary for Examination

The BEI terminal system is best understood as an endpoint-level state machine that ties together behavioral identity, signed event recording, domain-bound routing, permission execution, privacy proof, recovery, offline vaulting, and mesh synchronization. Each part constrains and supports the other parts. The result is a computer-implemented terminal architecture that remains verifiable across online, offline, transferred, delegated, inherited, disputed, and emergency states.

This non-repetitive disclosure intentionally supplies additional embodiments, matrices, protocol details, pseudocode, and implementation examples so that examination, continuation strategy, licensing review, and asset packaging can identify concrete support without relying on repeated filler. The BEI terminology is used to identify the inventor's integrated behavioral economic identity architecture, while the claims also describe the structure in functional computer-technical terms so that equivalents using different labels remain covered.

### Additional Differentiated Claim-Scope Examples

### Example 1—BEI Terminal for Multi-Party Recovery

A multi-party recovery implementation may require signatures or receipts from a personal recovery key, family recovery terminal, registry terminal, and institutional review terminal. The BEI terminal creates a recovery event record that includes a prior domain binding, new endpoint, key rotation state, recovery proof, affected permission tree nodes, and synchronization status. The record allows a later verifier to determine that a recovered terminal is a continuation of the same BEI state rather than a newly fabricated account.

### Example 2—BEI Permission Scope for AI-Agent Delegation

An AI-agent delegation implementation may define a role scope that includes allowed data type, permitted service endpoint, maximum duration, maximum value, audit requirement, revocation trigger, and privacy sidecar condition. When the agent acts, the BEI terminal treats the action as a terminal event and records the instruction, proof, endpoint, and decision. This prevents an AI agent from operating as an unrestricted credential holder.

### Example 3—BEI Wallet and Financial Dispute Evidence

A wallet and financial dispute implementation may compare a transaction request, wallet signature, BEI trust state, service authorization, and permission tree scope. If the transaction is later disputed, the terminal can produce an evidence package containing signed event records, domain-terminal binding, trust-score deltas, prior and current permission state, privacy proof references, and selected service receipts. The package supports review without requiring the entire behavioral history to be disclosed.

### Example 4—BEI Medical Emergency and Privacy Boundary

A medical emergency implementation may permit a provider node to receive limited emergency access while raw behavioral records remain protected. The terminal writes an emergency override record, specifies the clinical scope, expiration time, audit requirement, and reconciliation requirement, and later revokes or confirms the temporary scope. This makes emergency use technically accountable rather than merely discretionary.

### Example 5—BEI Registry and Domain Asset Continuity

A registry implementation may treat domain renewal, domain transfer, subdomain creation, and registry dispute review as terminal events. The domain asset is therefore linked to BEI identity, permission state, ledger state, recovery state, and synchronization status. This supports asset-package value because the domain is not merely an address; it is an executable identity and permission endpoint with auditable continuity.

### Example 6—BEI Time-Bound Participation Support

A time-bound participation implementation may record event duration, service contribution, consensus participation, validation status, dispute-free interval, and trust-weight effect. The terminal may use the resulting value as a governance utility, access priority, service credit, or evidence of contribution. The value is technically tied to signed ActionLedger events and is not required to be a speculative token.

### Examiner-Focused Technical Closing

The specification therefore provides support for both broad and narrow claim interpretation. At the broad level, the invention covers the integrated BEI terminal stack across hardware, software, hosted, edge, wallet, AI-agent, registry, medical, financial, educational, service provider, and hybrid nodes. At the narrow level, the specification provides field definitions, formulas, pseudocode, reconciliation rules, privacy proof structures, key rotation paths, emergency override records, and specific vertical flows.

The disclosed BEI system should not be interpreted as merely automating a human governance idea. It changes the operation of a terminal endpoint by creating and maintaining machine-verifiable state relationships among behavioral identity, signed records, domain routing, permission control, privacy protection, recovery, offline vaulting, and mesh synchronization. Those relationships provide the technical basis for patent eligibility, written description, enablement, non-obviousness, licensing, and asset-package valuation.

### Final Non-Limiting Implementation Notes

The disclosed BEI terminal architecture may be practiced with different storage engines, cryptographic libraries, network transports, domain registries, user interfaces, wallet frameworks, AI-agent systems, medical platforms, financial systems, educational systems, and community service platforms. These variations do not change the technical core when the terminal still generates a BEI identity state from signed events, stores the events in an ActionLedger, binds state to a domain-terminal address, executes a Permission Tree, preserves private evidence through a Privacy Sidecar, caches signed state in an Offline Trust Vault during disconnection, and reconciles through TrustNet after reconnection.

The examples also support layered claim strategy. A first claim layer protects the terminal system, a second layer protects method operation, a third layer protects computer-readable instructions, and additional layers support future continuation claims directed to BEI AI-agent terminals, BEI wallet authorization, BEI domain registry nodes, BEI medical consent, BEI financial trust, BEI educational credentials, BEI family inheritance, and BEI disaster recovery. The disclosure is therefore broad enough for asset packaging while remaining tied to concrete computer-technical structure and operation.

A further implementation may combine local BEI terminal execution with hosted verification services. For example, a mobile terminal may store private behavioral evidence locally, a domain endpoint may publish public service pointers, and a hosted verifier may receive only signed digests or privacy proofs. The ActionLedger state, DomainTalk binding, Permission Tree state, Offline Trust Vault, and TrustNet reconciliation metadata preserve a verifiable relationship among these distributed components even when the components are operated by different entities.

Because the BEI terminal creates signed records at the point where behavior, domain routing, permission scope, privacy mode, recovery state, and synchronization state intersect, the invention supplies technical evidence for access decisions and later disputes. The same structure also provides a practical boundary against design-arounds that move one function to a server, wallet, registry, AI agent, or service provider while preserving the same cross-linked terminal state machine.

1. A domain-bound behavioral economic identity terminal system, comprising: a plurality of programmable sovereign terminals, each comprising one or more processors and memory and configured to operate as a hardware, software, hosted, containerized, edge, wallet, artificial-intelligence-agent, domain-registry, or hybrid terminal node; a behavioral identity module configured to generate, for a corresponding programmable sovereign terminal, a multi-dimensional behavioral economic identity vector based on timestamped behavioral events, hardware-terminal interaction patterns, terminal engagement history, permission invocation patterns, service interactions, transaction-routing events, and cross-node communication telemetry; an action ledger module configured to store signed behavioral event records corresponding to the timestamped behavioral events, each signed behavioral event record including at least a terminal identifier, a domain identifier, an event type, a timestamp, a permission state, a ledger-state hash, and a cryptographic verification value; a domain-terminal mapping module configured to bind the behavioral economic identity vector and the terminal identifier to a domain-based terminal address, human-readable root domain namespace, or decentralized namespace identifier; a permission tree module configured to assign, delegate, inherit, revoke, recover, temporarily override, or scope access rights associated with the domain-based terminal address; and a synchronization module configured to synchronize signed behavioral event records, permission tree state, trust-score deltas, and domain-terminal mapping state with one or more remote terminal nodes through a TrustNet mesh verification process, wherein the programmable sovereign terminal operates as a verifiable identity, permission, service-routing, dispute-evidence, and behavioral governance endpoint across a plurality of domain-linked environments.

2. The system of claim 1, wherein the behavioral economic identity vector includes at least a behavior history hash, a domain-bound identity value, a role state value, a trust weight value, a permission status value, a recovery state value, and a privacy mode flag, and wherein a regenerative trust clearance process applies frequency, recency, validation status, peer attestation, service quality, dispute outcome, or decay-weighted metrics to update the trust weight value.

3. The system of claim 1, wherein the domain-terminal mapping module performs adaptive name routing by mapping a persistent human-readable domain name, subdomain name, uniform resource locator, decentralized namespace identifier, root domain namespace, or registry handle to a current terminal endpoint, service endpoint, audit endpoint, recovery endpoint, or synchronization endpoint.

4. The system of claim 1, wherein each programmable sovereign terminal includes a secure storage, secure enclave, trusted execution environment, hardware security module, or hardware-backed key store configured to protect a terminal key, privacy sidecar record, or signed behavioral event record.

5. The system of claim 1, wherein the permission tree module stores a parent-child permission relationship between an individual terminal node and at least one family, institutional, community, artificial-intelligence-agent, wallet, service-provider, medical, financial, educational, domain-registry, or organizational terminal node and further supports an autonomous governance module or smart contract template associated with a scoped permission subtree.

6. The system of claim 1, wherein the action ledger module stores signed behavioral event records in a hash-linked, radix-tree, Merkle-tree, directed-acyclic-graph, append-only database, local cache-ledger, distributed ledger, or other verifiable data structure configured to compare prior and current permission states, detect conflicts, and generate dispute evidence.

7. The system of claim 1, wherein the synchronization module includes an offline trust vault configured to cache signed behavioral event records, local ledger hashes, trust-score deltas, service requests, local signatures, peer receipts, quorum metadata, and conflict flags during a disconnected network state, and reconciles cached records after network reconnection by applying a timestamp rule, signature verification rule, quorum confirmation rule, conflict-free replicated data type rule, trust-weight priority rule, domain-priority rule, or permission-priority rule.

8. The system of claim 1, wherein the permission tree module executes an emergency override, disaster governance rule, medical condition rule, family recovery rule, or institutional continuity rule that grants a temporary access scope and records the temporary access scope in the action ledger for later reconciliation.

9. The system of claim 1, wherein the programmable sovereign terminal tracks a participation value, time-bound governance utility value, or service credit based on validated participation, consensus confirmation, service quality, peer attestation, dispute outcome, or time-bound contribution recorded in the action ledger.

10. A computer-implemented method for operating a domain-bound behavioral economic identity terminal, the method comprising: receiving, by a terminal device, a behavioral event associated with a user, role, permission state, hardware-terminal interaction, network-routing interaction, service interaction, artificial intelligence agent, wallet application, domain registry operation, institutional request, or emergency condition; generating, by the terminal device, a behavioral economic identity vector based at least in part on the behavioral event; creating a signed behavioral event record including a terminal identifier, a domain identifier, an event type, a timestamp, a prior or current permission state, and a cryptographic verification value; storing the signed behavioral event record in an ActionLedger associated with the terminal device; binding the terminal identifier to a domain-based terminal address; updating a permission tree associated with the domain-based terminal address based on the signed behavioral event record; routing a service request according to the updated permission tree; and synchronizing the signed behavioral event record or the updated permission tree with one or more remote terminal nodes through a TrustNet mesh verification process.

11. The method of claim 10, further comprising validating control of the domain-based terminal address and storing a signed domain-terminal binding record that includes a domain label, terminal identifier, behavioral economic identity reference, controller role, routing policy, service pointer, key identifier, validity metadata, and signature.

12. The method of claim 10, further comprising assigning a first role to a first terminal node and assigning a second role to a second terminal node, wherein the first role and the second role define different access rights in the permission tree and wherein the access rights are executed through a domain-specific policy rule, autonomous governance module, or smart contract template.

13. The method of claim 10, further comprising generating a dispute evidence package including one or more signed behavioral event records, one or more timestamps, one or more permission state changes, one or more role states, one or more trust-score deltas, one or more terminal state hashes, and one or more domain-terminal mapping records.

14. The method of claim 13, further comprising transmitting the dispute evidence package to a consensus verification node, geo-federated node subset, family recovery node, institutional review node, or registry dispute node for validating a disputed permission state, behavioral event, service request, registry operation, wallet operation, or AI-agent instruction.

15. The method of claim 10, further comprising rotating a cryptographic key associated with the terminal identifier in response to a terminal transfer, domain transfer, recovery event, compromised credential, role transition, scheduled rotation interval, inheritance trigger, or terminal-level intrusion event.

16. A non-transitory computer-readable medium storing instructions that, when executed by one or more processors of a terminal device, cause the terminal device to: generate a behavioral economic identity vector for a terminal based on timestamped behavioral events; store signed behavioral event records in an ActionLedger; bind a terminal identifier to a domain-based terminal address; maintain a permission tree for assigning, delegating, inheriting, revoking, recovering, or temporarily overriding access rights; cache signed behavioral event records in an offline trust vault during a disconnected network state; synchronize the cached signed behavioral event records with one or more remote terminal nodes through a TrustNet mesh verification process after network reconnection; and route one or more service requests according to the domain-based terminal address and the permission tree.

17. The non-transitory computer-readable medium of claim 16, wherein the instructions further cause the terminal device to generate a terminal state package including the behavioral economic identity vector, a permission tree state, a ledger state hash, a trust-score delta, a domain-terminal mapping state, a synchronization status value, and reconciliation metadata.

18. The non-transitory computer-readable medium of claim 16, wherein the instructions further cause the terminal device to issue a machine-readable credential to an artificial intelligence agent, wallet application, service provider, family node, institutional node, medical node, financial node, educational node, community node, or domain registry node based on the permission tree.

19. The non-transitory computer-readable medium of claim 16, wherein the instructions further cause the terminal device to apply privacy-respecting dual-mode behavioral encryption that permits verification of a trust vector, domain-terminal state, or permission state while limiting disclosure of raw behavioral evidence.

20. The non-transitory computer-readable medium of claim 16, wherein the instructions further cause the terminal device to perform local ad-hoc mesh exchange, geo-federated node indexing, adaptive name routing, or cross-domain policy translation while preserving a signed relationship among behavioral identity state, ActionLedger state, domain-terminal mapping state, permission tree state, and TrustNet synchronization state.
